(19) United States
(12) Patent Application Publication
(10) Pub. No.: US 2015/0319246 A1
(43) Pub. Date: Nov. 5, 2015

(54) DATA TRANSMISSION DEVICE, DATA TRANSMISSION METHOD, AND STORAGE MEDIUM

(71) Applicant: NEC CORPORATION, Minato-ku, Tokyo (JP)

(72) Inventor: Kazuhisa ISHIZAKA, Tokyo (JP)

(21) Appl. No.: 14/650,333

(22) PCT Filed: Dec. 5, 2013
(86) PCT No.: PCT/JP2013/007146

§ 371 Date: Jun. 8, 2015

(30) Foreign Application Priority Data
Dec. 7, 2012 (JP) 2012-268120

(51) Int. Cl. H04L 29/08; G06F 3/06

(52) U.S. Cl. CPC H04L 67/1097; G06F 3/0604; G06F 3/0647; G06F 3/0683

(57) ABSTRACT

[Problem] To provide a data transfer device that efficiently reduces the transfer of data that does not need to be transferred.

[Solution] This data transmission device is provided with: a memory; a processor that carries out writing to the memory; detection means for detecting the writing to the memory and identifiably detecting an update range, which is the range of the memory in which the writing is detected; extraction means for extracting, in response to receiving from the processor a transfer command specifying a transfer range in the memory, a range of the received transfer range included in the update range, as a transfer execution range; and transfer means for performing a data transfer that transfers to a transfer-destination node data stored in the transfer execution range of the memory.

### TECHNICAL FIELD

The present invention relates to a data transmission device, a data transmission method, and a data transmission program, and more particularly to a data transmission device, a data transmission method and a data transmission program in data transmission in a distributed memory system.

### BACKGROUND ART

In a distributed memory system which is configured with a plurality of nodes each of which includes an independent memory space and processor, when the plurality of nodes carry out processing in coordination with one another, data transfer between the nodes is, in general, carried out multiple times. Because it is known that such data transfer becomes a performance bottleneck, it is preferable to reduce data transfer operations as much as possible.

FIG. 1 is a block diagram illustrating an example of a distributed memory system.

Programming models for a distributed memory system include an offload model, which is used in a system including an accelerator, such as GPGPU (General-Purpose computing on Graphics Processing Units). The offload model is a model in which a host node instructs data transfer to an accelerator node and call of processing.

FIG. 2 is a diagram illustrating an example of an order of processing carried out by a system which uses the offload model. In the example in FIG. 2, the node 0 is a host node and the node 1 is an accelerator node.

A library which includes an offload function is provided for such a system. This library carries out, in library functions, data transfer to an accelerator and call of processing. With this configuration, it is possible for a program using the library to use the accelerator without carrying out procedures, such as data transfer.

FIG. 3 is a diagram illustrating an example of sharing of processing between a program and a library on a host node.

In such a library, when a library function to carry out offloading is called multiple times, data transfer is generally carried out every time the library function is called. This is because the library is incapable of deciding whether or not data have been changed during the multiple calls and, thus, compelled to employ a method to transmit data again. When the data have not been changed since the last call, it is essentially useless to transmit the data again. Thus, there is a problem in that, when such a library is used, useless transfer is carried out.

A manual of an example of a library that reduces useless data transfer is described in NPL 2. NPL 2 is a manual of the MAGAMA library. The MAGAMA library is a library for a GPU (Graphics Processing Unit).

This library includes both a library function which carries out data transfer and call of processing and a library function which carries out only call of processing. Users of this library, when it is apparent that data exist on an accelerator and the data is not updated, use the latter library function among the two library functions described above. With this configuration, useless data transfer is not carried out.

In PTL 1, a system which uses a virtual shared memory in a plurality of nodes to reduce such useless data transfer is described. A virtual shared memory is also referred to as a software distributed shared memory.

Each of the nodes described in PTL 1 includes a processor which executes a threaded program and a distributed memory which is arranged in distributed manner over respective nodes. Each of the nodes, in starting a program, transforms the program into a write-side thread which carries out writing of data to the memory and a read-side thread which carries out reading of data from the memory. Then, each of the nodes executes the transformed thread program on a processor thereof. The write-side thread carries out writing of data to the distributed memory of the node at which the write-side thread is executed. When the write-side thread and the read-side thread which reads data that the write-side thread has written are executed at different nodes, the write-side node transfers the written data to the read-side node. The read-side node which receives data writes the data to the distributed memory of the read-side node. The read-side node further starts the read-side thread. The read-side thread reads the data from the memory of the read-side node.

In NPL 1, an asymmetric distributed shared memory method in which a distributed shared memory is implemented on an offload-model-based system in which an accelerator node does not have a function to monitor memory access is described. In this method, monitoring of memory access is carried out only on a host node. When the host node makes the accelerator node carry out processing, all shared data that the host node has written since the host node made the accelerator node carry out the processing last time are transferred to the accelerator. With this processing, the host node makes data required for the accelerator to carry out the processing exist on the accelerator.

In PTL 2, an onboard device which, when a cellphone is connected, decides whether or not emails stored in the cellphone have been updated and, if some emails have been updated, obtains the emails from the cellphone is described.

In PTL 3, an information providing system which, when a data acquisition request for summary information of contents is received from a cellphone, transmits data of the summary information to the cellphone is described. Only when data of summary information specified in the last acquisition request have been updated, the information providing system described in PTL 3 transmits data of new summary information after update to the cellphone.

### CITATION LIST

### Patent Literature

[PTL 1] Japanese Unexamined Patent Application Publication No. 2003-036179
[PTL 2] Japanese Unexamined Patent Application Publication No. 2012-128498
[PTL 3] Japanese Unexamined Patent Application Publication No. 2012-069139

### Non Patent Literature

[NPL 1] “An Asymmetric Distributed Shared Memory Model for Heterogeneous Parallel Systems”, Isaac Gelado, et al., ASPLOS2010
[NPL 2] MAGMA version 0.2 Users' Guide, http://icl.cs.utk.edu/projectsfiles/magma/docs/magma-v02.pdf

### SUMMARY OF INVENTION

### Technical Problem

When the library described in NPL 2 is used, a user of the library needs to decide whether or not data exist on an accelerator. When a plurality of pieces of data are transferred in the library, it is difficult not to transfer a portion of the data. Thus, in this case, data that do not need to be transferred are sometimes transferred.

In the technology described in PTL 1, when a write-side thread and a read-side thread are executed on different nodes, data transfer is carried out every time writing of data to a memory is carried out. Thus, in the technology described in PTL 1, overhead for data transfer is high. Furthermore, in the technology described in PTL 1, every time writing of data to a memory is carried out, the write-side thread ends and the read-side thread is started. Thus, in the technology described in PTL 1, overhead for processing accompanied by writing of data to a memory is high.

In the method described in NPL 1, a host node transfers all data that have been updated regardless of whether or not the data are used in processing on an accelerator. Thus, in the method described in NPL 1, data that do not need to be transferred are sometimes transferred.

The technologies described in PTLs 2 and 3 are incapable of reducing transmission of data that do not need to be transmitted in a distributed memory system configured with a plurality of nodes.

An object of the present invention is to provide a data transmission device which efficiently reduces transfer of data that do not need to be transferred.

### Solution to Problem

A data transmission device of the present invention includes a memory, a processor that carries out writing to the memory, a detection means for detecting writing to the memory and identifying an update range which is a range for which writing is detected in the memory, an extraction means for receiving, from the processor, a transfer instruction which specifies a transfer range in the memory and, at every reception, extracting, as a transfer execution range, a range included in the update range within the received transfer range, and a transfer means for carrying out data transfer to transfer data stored in the transfer execution range in the memory to a transfer-destination node.

A data transmission method of the present invention includes the steps of detecting writing to a memory to which writing is carried out by a processor, identifying an update range which is a range for which writing is detected in the memory, in response to receiving, from the processor, a transfer instruction which specifies a transfer range in the memory, extracting, as a transfer execution range, a range included in the update range within the received transfer range, and carrying out data transfer to transfer data stored in the transfer execution range in the memory to a transfer-destination node.

A recording medium of the present invention stores a data transmission program that makes a computer, which includes a memory and a processor to carry out writing to the memory, operate as a detection means for detecting writing to the memory and identifying an update range which is a range for which writing is detected in the memory, an extraction means for, in response to receiving, from the processor, a transfer instruction which specifies a transfer range in the memory, extracting, as a transfer execution range, a range included in the update range within the received transfer range, and a transfer means for carrying out data transfer to transfer data stored in the transfer execution range in the memory to a transfer-destination node.

It is also possible to implement the present invention by such a data transmission program stored in a recording medium.

### Advantageous Effects of Invention

The present invention has an advantageous effect such that it is possible to efficiently reduce transfer of data that do not need to be transferred.

### BRIEF DESCRIPTION OF DRAWINGS

FIG. 1 is a block diagram illustrating an example of a distributed memory system.

FIG. 2 is a diagram illustrating an example of an order of processing which is carried out in a system using an offload model.

FIG. 3 is a diagram illustrating an example of sharing of processing between a program and a library on a host node.

FIG. 4 is a block diagram illustrating an example of a structure of the whole of an information processing system 100 of a first exemplary embodiment.

FIG. 5 is a block diagram illustrating an example of a detailed structure of the information processing system 100 of the first exemplary embodiment.

FIG. 6 is a flowchart illustrating an operation of the first and a second exemplary embodiments in detecting writing.

FIG. 7 is an example of update ranges stored by an update range storage unit 11.

FIG. 8 is a flowchart illustrating an operation of a host node 1 of the first exemplary embodiment in transferring data.

FIG. 9 is a block diagram illustrating a structure of an information processing system 100A of the second exemplary embodiment.

FIG. 10 is a flowchart illustrating an operation of a host node 1A of the second exemplary embodiment in transferring data.

FIG. 11 is a block diagram illustrating a structure of an information processing system 100B of a third exemplary embodiment.

FIG. 12 is a flowchart illustrating an operation of a host node 1B of the third exemplary embodiment in detecting writing.

FIG. 13 is a diagram illustrating an example of a history of writing stored in a history storage unit 15.

FIG. 14 is a flowchart illustrating an operation of the host node 1B of the third exemplary embodiment in detecting data transfer.

FIG. 15 is a block diagram illustrating a structure of an information processing system 100C of a fourth exemplary embodiment.

FIG. 16 is a block diagram illustrating an example of a structure of an information processing system 100D of a fifth exemplary embodiment.

FIG. 17 is a block diagram illustrating a structure of a data transmission device 1C of a sixth exemplary embodiment.

FIG. 18 is a diagram illustrating a summary of an information processing system 100 of a first configuration example of the present invention.

FIG. 19 is a diagram illustrating a detailed configuration of an offload library 50.

FIG. 20 is a diagram illustrating a configuration of a data monitoring unit 52 of the first configuration example.

FIG. 21 is an example of a program 40 of the first configuration example.

FIG. 22 is an example of a function to carry out multiplication that the offload library 50 of the first configuration example includes.

FIG. 23 is a diagram illustrating a transfer data table in an initial state.

FIG. 24 is a diagram illustrating the transfer data table which has been updated after transmission of matrices a and b.

FIG. 25 is a diagram illustrating a data update table 91 which has been updated after transmission of the matrices a and b.

FIG. 26 is a diagram illustrating the data update table 91 which has been changed after carrying out writing to the matrix a.

FIG. 27 is a diagram illustrating a configuration of a second configuration example.

FIG. 28 is a diagram illustrating an example of a data transmission function of a data transfer library 50A of the second configuration example.

FIG. 29 is a diagram illustrating a configuration of a third configuration example.

FIG. 30 is a diagram illustrating a configuration of a fourth configuration example.

FIG. 31 is a diagram illustrating an example of another embodiment of the fourth configuration example.

FIG. 32 is a diagram illustrating a summary of a configuration of the fifth configuration example.

FIG. 33 is a diagram illustrating a detailed configuration of each node of the present configuration example.

FIG. 34 is a diagram illustrating an example of a structure of a computer 1000 which is used to implement the host node 1, the host node 1A, the host node 1B, the data transmission device 1C, a transfer-source node 1D, an accelerator node 3, an accelerator node 3A, and a transfer-destination node 3D.

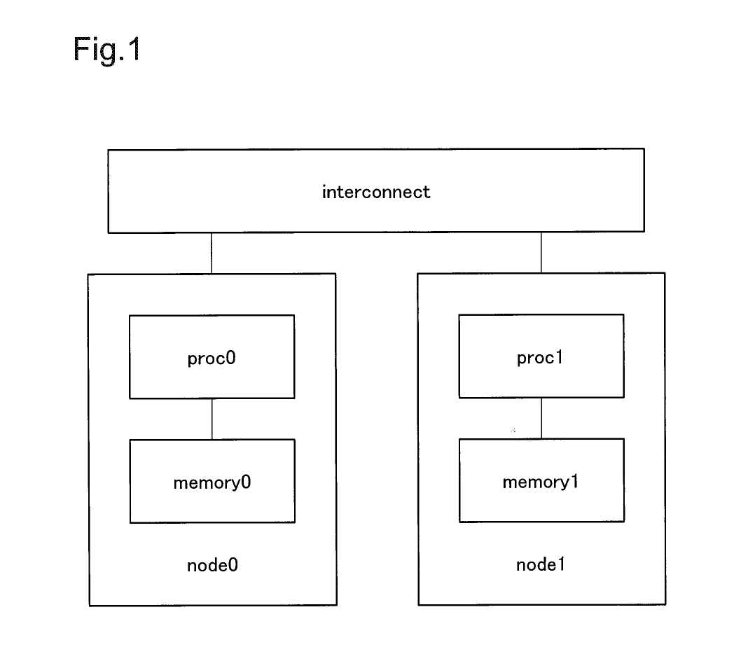

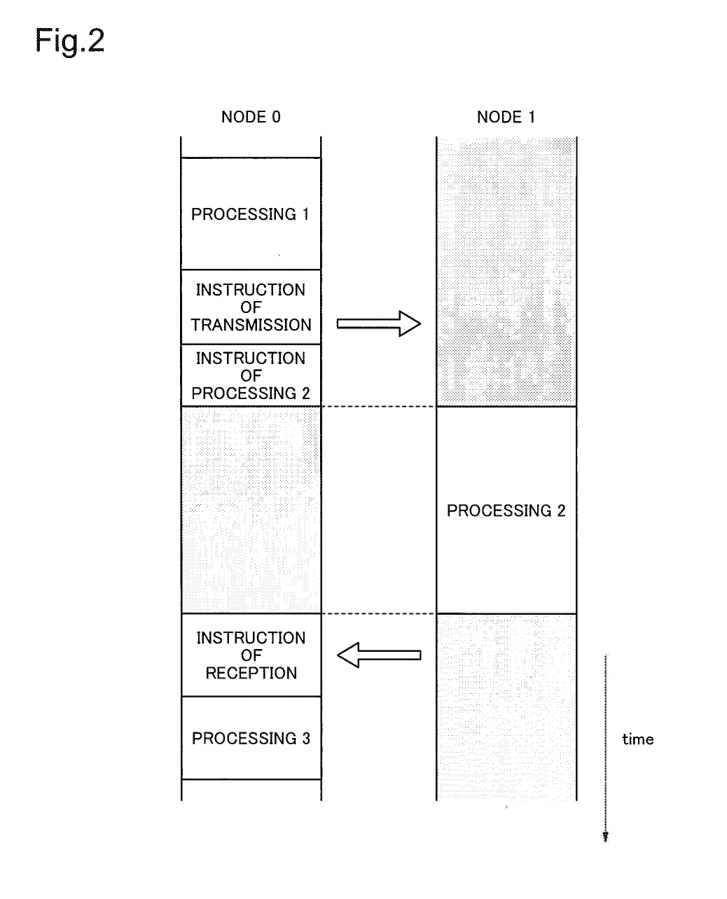

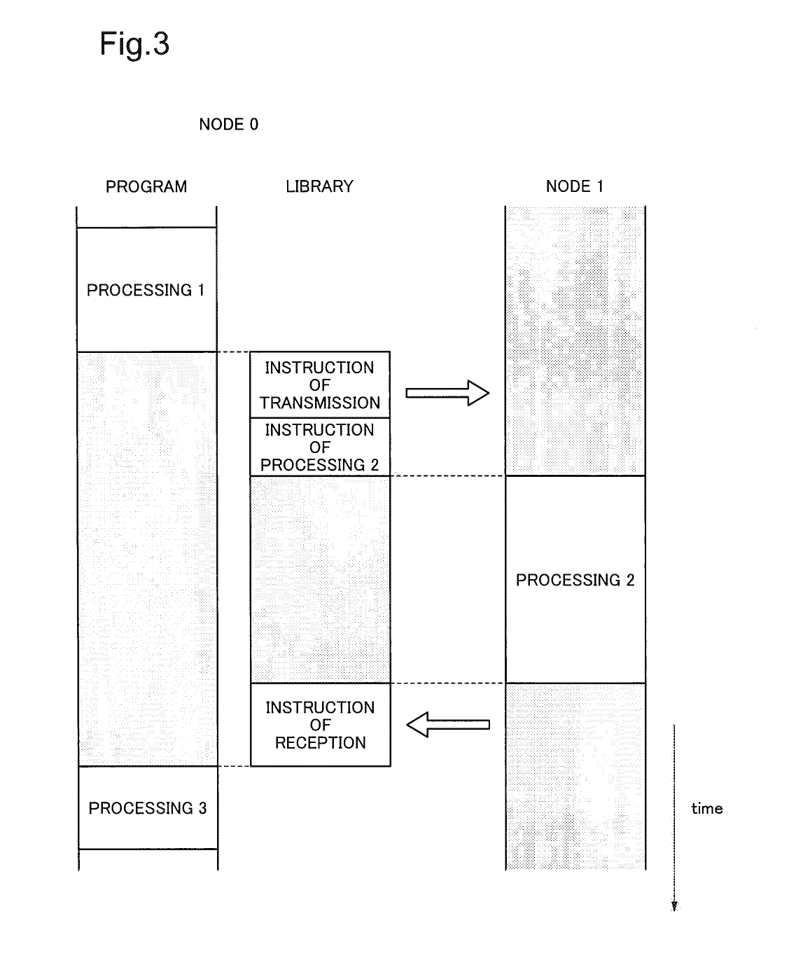

### DESCRIPTION OF EMBODIMENTS

Next, exemplary embodiments to carry out the present invention will be described in detail with reference to the accompanying drawings.

### First Exemplary Embodiment

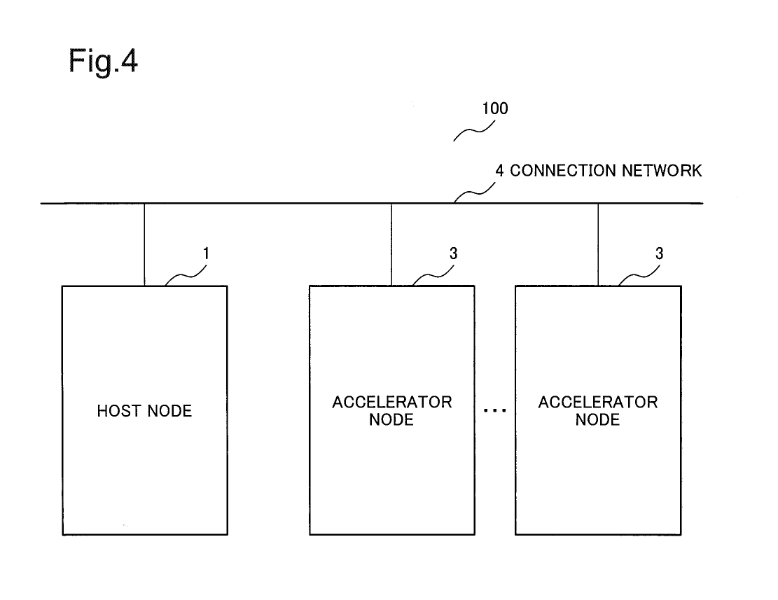

FIG. 4 is a block diagram illustrating an example of a structure of the whole of an information processing system 100 of a first exemplary embodiment of the present invention.

With reference to FIG. 4, the information processing system 100 includes a host node 1 and an accelerator node 3. The information processing system 100 may include a plurality of accelerator nodes 3. The host node 1 and each of the accelerator nodes 3 are interconnected by a connection network 4, which is a communication network. The host node 1, each of the accelerator nodes 3, and the connection network 4 may be included in a single device.

In the description of the present exemplary embodiment and other exemplary embodiments, which will be described later, structures and operations for a case of a single accelerator node 3 will be mainly described. In the block diagrams hereinafter described, which illustrate detailed structures of each of the exemplary embodiments, the connection network 4 will not be illustrated.

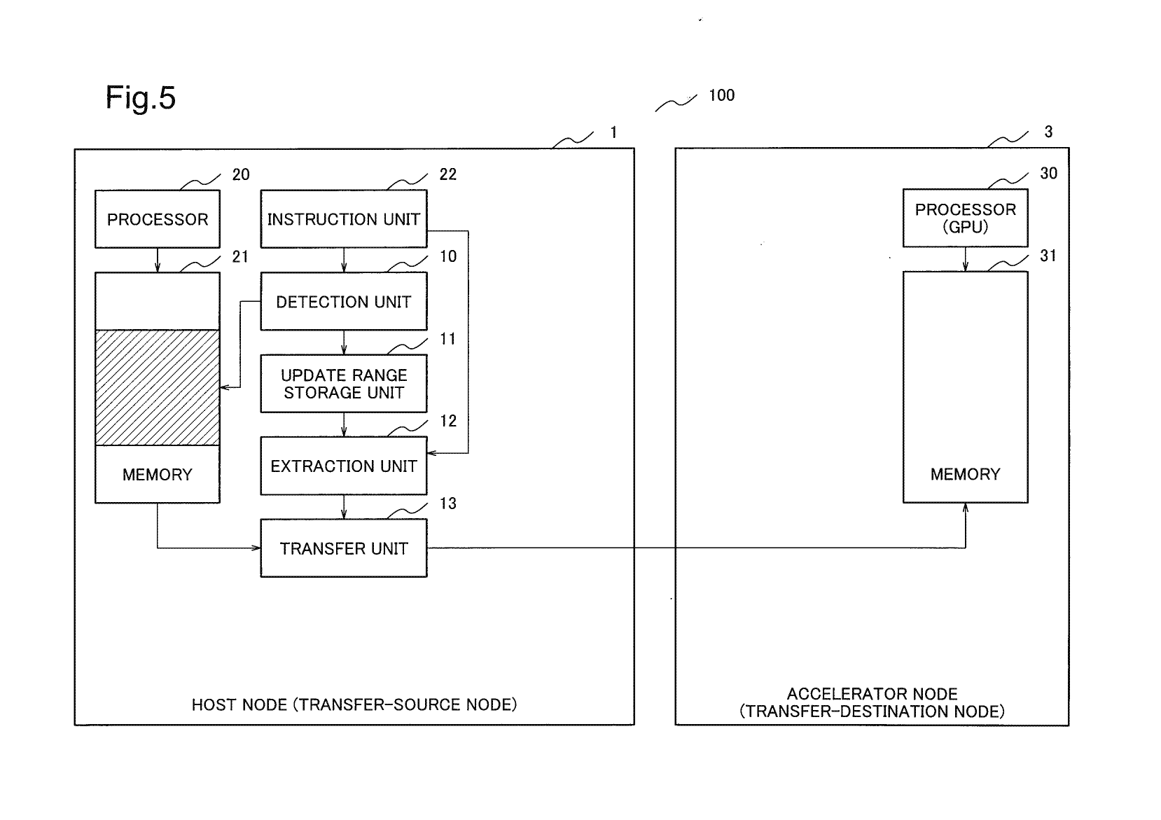

FIG. 5 is a block diagram illustrating an example of a detailed structure of the information processing system 100 of the present exemplary embodiment.

With reference to FIG. 5, the information processing system 100 of the present exemplary embodiment includes the host node 1 and the accelerator node 3. The host node 1 is a data transmission device which includes a processor 20 and a memory 21. The host node 1 executes, by the processor 20, a program to carry out processing including writing to the memory 21. The host node 1 transmits data stored in the memory 21 to the accelerator node 3.

The host node 1 includes a detection unit 10, an update range storage unit 11, an extraction unit 12, and a transfer unit 13. Further, the host node 1, in addition to the processor 20 and the memory 21, includes an instruction unit 22. The instruction unit 22 is, for example, the processor 20 which is controlled by a program and operates as the instruction unit 22. The program which makes the processor 20 operate as the instruction unit 22 may be an OS (Operating System) operating on the processor 20, a library operating on the OS, or a user program operating by using one or both of the OS and the library.

The accelerator node 3 includes a processor 30 and a memory 31. The accelerator node 3 is, for example, a graphics accelerator. The processor 30 is, for example, a GPU (Graphics Processing Unit).

In the information processing system 100 of the present exemplary embodiment, a distributed memory system which uses an offload model between the host node 1 and the accelerator node 3 is employed.

On the host node 1, the processor 20 configured to execute a program carries out processing while reading and writing data stored in the memory 21. The processor 20 makes the processor 30 of the accelerator node 3 carry out a portion of processing which uses data stored in the memory 21. For that purpose, the host node 1 transmits the data stored in the memory 21 to the accelerator node 3. In the present exemplary embodiment, the host node 1 is a transfer-source node of data, and the accelerator node 3 is a transfer-destination node of the data.

The instruction unit 22 transmits, to the extraction unit 12, a transfer instruction, which is an instruction to transfer data stored in the memory of the transfer-source node within a range, for example, determined by the program. The transfer instruction may include a transfer range, which is a range, in the memory, in which data to be transferred are stored. The transfer instruction may be a transfer range itself. A range of the memory is represented by, for example, the head address and the size of a region in the memory in which data are stored. A range of the memory may be represented by a plurality of combinations of head addresses and sizes. The transfer range in the present exemplary embodiment is a range in the memory 21 of the host node 1.

The detection unit 10 detects writing to the memory 21 within a preset range. A range, in the memory 21, for which the detection unit 10 detects writing is referred to as a monitoring range. In the present exemplary embodiment, the monitoring range is a part or the whole of the memory 21. The monitoring range may be prefixed. The detection unit 10 may, for example, receive the monitoring range from the instruction unit 22. In that case, the instruction unit 22 may, for example, transmit, to the detection unit 10, the monitoring range that the processor 20 controlled by a program operating on the processor 20 determines.

The detection unit 10 stores, in the update range storage unit 11, a range for which writing is detected. The range, in the memory of a transfer-source node, for which writing is detected is referred to as an update range. The update range of the present exemplary embodiment is a range, in the memory 21, for which writing is detected.

The update range storage unit 11 stores an update range detected by the detection unit 10.

In the present exemplary embodiment, the accelerator node 3, which is the transfer-destination node, holds data which are identical to data stored in the memory 21 within the monitoring range excluding the update range. For example, when detection of writing by the detection unit 10 starts, data stored in the memory 21 within the monitoring range may have been transferred to the accelerator node 3, which is the transfer-destination node, in advance. The update range storage unit 11 may store no update range. Alternatively, when the detection of writing starts, the update range storage unit 11 may store, as the update range, a range in which data that the accelerator node 3 does not hold are stored, within the monitoring range in the memory 21.

The extraction unit 12 obtains the transfer range from the instruction unit 22 of the host node 1 by, for example, receiving the transfer instruction described above.

The extraction unit 12 extracts a range included in the update range, which is stored in the update range storage unit 11, within the transfer range. In other words, the extraction unit 12 extracts, as a transfer execution range, a range for which writing has been carried out and stored data have been updated, within the transfer range. In the present exemplary embodiment, as described below, the transfer unit 13 transfers data stored in the transfer execution range in the memory 21. When a range that is not included in the monitoring range exists in the transfer range, the extraction unit 12 may further extract the ranges which is included in the transfer range but not included in the monitoring range, as the transfer execution range.

The transfer unit 13 transfers data stored in the transfer execution ranges in the memory 21 to the accelerator node 3, which is the transfer-destination node. The transfer unit 13 may write the transferred data to the memory 31 of the accelerator node 3. The accelerator node 3 may also include a reception unit 32 which receives data and writes the received data to the memory 31, as described below. The transfer unit 13 may also transmit the data to be transferred to the reception unit 32.

Next, an operation of the host node 1 of the present exemplary embodiment will be described in detail with reference to the accompanying drawings.

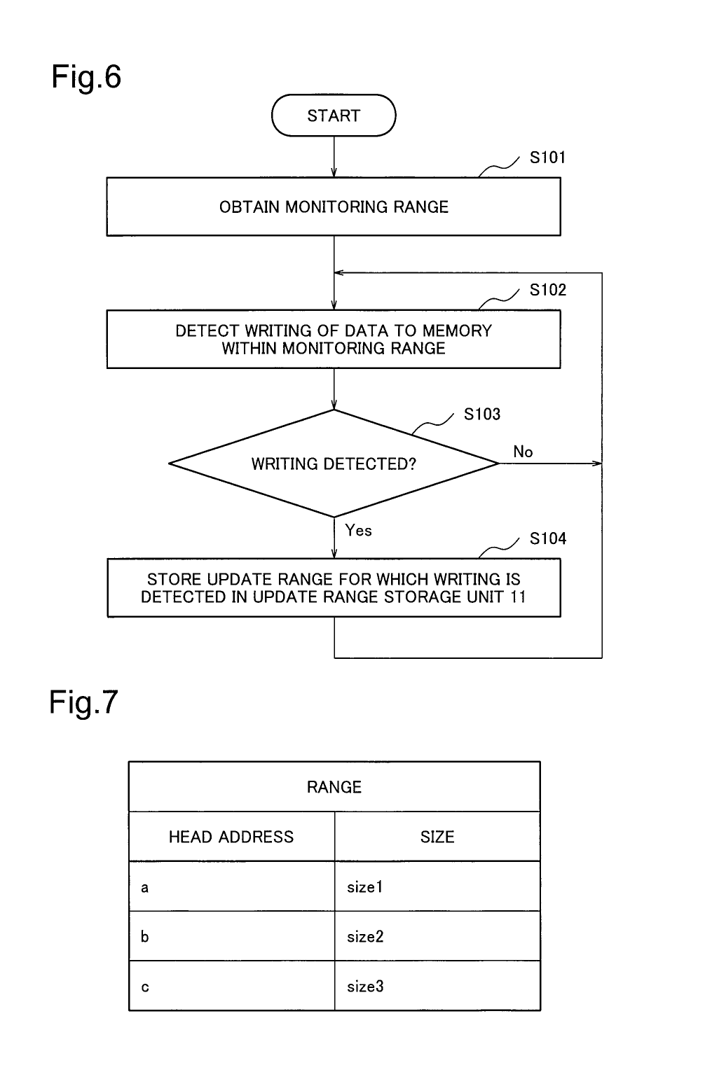

FIG. 6 is a flowchart illustrating an operation of the host node 1 of the present exemplary embodiment in detecting writing.

When the operation of the host node 1 illustrated in FIG. 6 starts, the accelerator node 3, which is the transfer-destination node, holds data which are identical to data stored in the monitoring range in the memory 21. In the update range storage unit 11, no update range is stored.

With reference to FIG. 6, the detection unit 10 first obtains the monitoring range from the instruction unit 22 (step S101).

Shaded areas in the memory 21 illustrated in FIG. 5 and other drawings illustrate an example of the monitoring range. The monitoring range may be a part or the whole of the memory 21. The monitoring range may be determined by, for example, a designer of the host node 1 in advance. In this case, the monitoring range may include a range that has a possibility that writing is carried out. In a case of the monitoring range being prefixed, the host node 1 does not have to carry out the operation in step S101. As illustrated in the example in FIG. 6, when the detection unit 10 obtains the monitoring range from the instruction unit 22, for example, the processor 20 controlled by a program may determine the monitoring range. The processor 20 controlled by a program may, for example, determine the monitoring range so that the monitoring range becomes a range that is identical to the transfer range in which data which are transferred to the accelerator node 3 and used in processing carried out by the accelerator node 3 are stored.

Next, the detection unit 10 detects writing to the memory 21 within the monitoring range (step S102).

In the example of the present exemplary embodiment, the detection unit 10 detects an update of data stored in the memory 21 by detecting writing to the memory 21. In the description of a specific example of the present exemplary embodiment, which will be described later, an example of a method to detect writing to the memory 21 by the detection unit 10 will be described in detail. The detection unit 10 may detect an update of data by other methods.

When no writing is detected (No in step S103), the detection unit 10 continues monitoring writing to the memory 21 within the monitoring range. That is, the operation of the host node 1 returns to step S102.

When writing is detected (Yes in step S103), the detection unit 10 stores an update range, which is a range for which writing is detected, in the update range storage unit 11 (step S104).

FIG. 7 illustrates an example of update ranges that the update range storage unit 11 stores.

The update range storage unit 11 stores, for example, a combination of the head address of an area to which data are written and the size of the written data, as an update range. The update range storage unit 11 may store an update range represented by a plurality of combinations of head addresses and sizes. In a case in which an update range has already been stored in the update range storage unit 11 when writing is detected, the detection unit 10 updates the update range stored in the update range storage unit 11. When the update range storage unit 11 stores the update range in the form of the example illustrated in FIG. 7, the detection unit 10 may add a newly detected update range to the update range storage unit 11. When the same update range as the detected update range has already been stored in the update range storage unit 11, the detection unit 10 does not have to update the update range. When the newly detected update range and the update range stored in the update range storage unit 11 overlap one another, the detection unit 10 may update the update range stored in the update range storage unit 11 in such a way that the update range stored in the update range storage unit 11 includes the newly detected update range.

After the operation in step S104 has finished, the operation of the host node 1 returns to step S102.

Next, an operation of the host node 1 in transferring data will be described in detail with reference to the accompanying drawings.

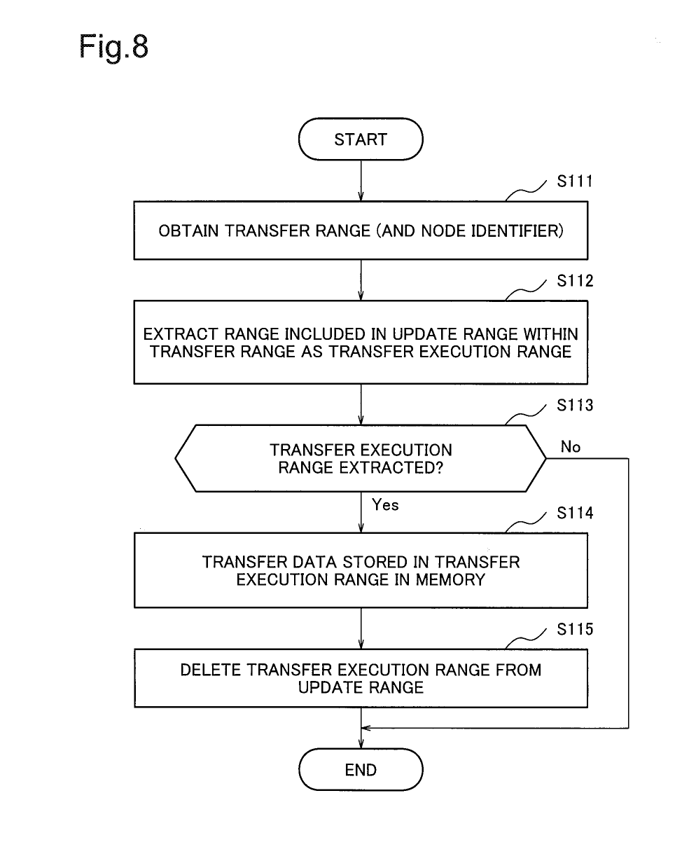

FIG. 8 is a flowchart illustrating an operation of the host node 1 in transferring data.

The instruction unit 22 of the host node 1 transmits the transfer range to the extraction unit 12, and instructs transfer of data stored in the transfer range in the memory 21. Transmitting the transfer range to the extraction unit 12 of the host node 1 may be the instruction of transfer of data. When the information processing system 100 includes a plurality of accelerator nodes 3, the instruction unit 22 may transmit, in addition to the transfer range, a node identifier of an accelerator node 3, which is a transfer destination, to the extraction unit 12 of the host node 1.

With reference to FIG. 8, the extraction unit 12 first obtains the transfer range from the instruction unit 22 of the host node 1 (step S111).

As described above, the transfer range is, for example, a combination of the head address and the size of an area in which data to be transferred are stored. The transfer range may be a list including a plurality of combinations of head addresses and sizes.

When the information processing system 100 includes a plurality of accelerator nodes 3, the extraction unit 12 obtains, in addition to the transfer range, a node identifier of an accelerator node 3, which is a transfer destination, from the instruction unit 22. For example, when an accelerator node 3, which is a transfer destination, is specified as in a case in which the information processing system 100 includes only one accelerator node 3, the extraction unit 12 does not have to obtain the node identifier of the accelerator node 3, which is the transfer destination.

Next, the extraction unit 12 extracts as the transfer execution range a range included in the update range in the transfer range (step S112).

As described above, the transfer range may have been set so as to be included in the monitoring range. When a range that is not included in the monitoring range exists in the transfer range, the extraction unit 12 may also extract the range as a part of the transfer execution ranges. Even in that case, the extraction unit 12 does not extract, as a part of the transfer execution ranges, a ranges that is included in the transfer range and the monitoring range but not included in the update ranges.

The accelerator node 3, which is a transfer-destination node, holds data which are at least identical to data stored in a range to which no writing has been carried out within the monitoring range in the memory 21. On the other hand, data stored in a range to which writing has been carried out within the monitoring range in the memory 21 have been updated due to the writing. The accelerator node 3 does not always hold data which are identical to data stored in the range in the memory 21 to which writing has been carried out. A range in the memory 21 in which data for which writing is detected are stored is the update range. The extraction unit 12 extracts, as the transfer execution range, a range in which writing is detected within the transfer range, by extracting a range included in the update range within the transfer range. In other words, the extraction unit 12 specifies, as a transfer target, data to which writing has been carried out, among data stored in the transfer range.

When there is no transfer execution range (No in step S113), the process ends. If the transfer range is included in the monitoring range, a range, within the transfer range, which stores data to which writing has been carried out is the transfer execution range. In that case, when no data to which writing has been carried out exists in the data stored in the transfer range, the process ends. If a range which is not included in the monitoring range exist within the transfer range and the range is extracted as the transfer execution range, the transfer execution range exists regardless of existence or non-existence of writing to the data stored in the transfer range.

When the transfer execution range exists (Yes in step S113), the process proceeds to step S114. When data to which writing has been carried out exist among the data stored in the transfer range, a range in which the data to which writing has been carried out are stored is included in the transfer execution range. If a range, within the transfer range, which is not included in the monitoring range exists and the range is extracted as the transfer execution range, the process proceeds to step S114.

In step S114, the transfer unit 13 transmits data stored in the memory 21 within the transfer execution range, which is extracted by the extraction unit 12, to the accelerator node 3, which is a transfer-destination node.

A range in the memory 31 in which transferred data are stored will be hereinafter referred to as a storage range. The storage range is, for example, determined by the transfer-source node. The transfer unit 13 may, for example, obtain the storage range from the instruction unit 22. The transfer unit 13 may determine the storage range. The transfer-destination node may determine the storage range.

The transfer unit 13 may be configured to directly read data stored in the memory 21 and directly write the read data to the memory 31 of the accelerator node 3. The transfer unit 13 may also be configured to transmit data to the reception unit 32, which writes the data to the memory 31. In this case, when the transfer-destination node is not configured to determine a storage range, the transfer unit 13 may transmit a storage range in addition to the data to the reception unit 32. The reception unit 32 may then store the transferred data in the storage range in the memory 31.

After the data transfer has finished, the transfer unit 13 deletes a range, within the transfer execution range, from which data stored therein have been transferred, from the update range stored in the update range storage unit 11 (step S115).

With this processing, a range from which data stored therein have been transferred does not become a data transfer target when writing to the range is not carried out again by the time the extraction unit 12 obtains a transfer range next time, even when the range is included in the transfer range.

The present exemplary embodiment described thus far has a first advantageous effect such that it is possible to efficiently achieve a reduction in the transfer of data not required to be transferred.

That is because the extraction unit 12 extracts, as the transfer execution range, a range included in the update range within the transfer range included in the monitoring range, and does not extracts a range not included in the update range as the transfer execution range. The transfer unit 13 transmits data stored in the transfer execution range in the memory 21 to the transfer-destination node. That is, the transfer unit 13 transmits only data to which writing has been carried out, among data stored in the monitoring range and in the transfer range, which is a range for which data transfer is instructed, in the memory 21. As described above, in the present exemplary embodiment, the transfer-destination node holds data which are identical to data stored in the memory within a range that is not included in the update range, within the monitoring range, in the transfer-source node. Transfer of data held by the transfer-destination node is a useless data transfer. Therefore, it is possible to reduce useless data transfer by the transfer unit 13 transmitting only data to which writing has been carried out among data stored in the memory within the transfer range in the transfer-source node.

The present exemplary embodiment also has a second advantageous effect such that it is possible to reduce a load to monitor existence or non-existence of writing to the memory 21.

That is because the extraction unit 12 further extracts, as the transfer execution range, a range which is included in the transfer range but not included in the monitoring range. When a range in the memory 21 is included in the transfer range, data stored in the range are transmitted to the transfer-destination node. Thus, the present exemplary embodiment makes it possible to reduce a load to monitor existence or non-existence of writing by, for example, excluding a range in which small size data are stored from the monitoring range in advance, or limiting the monitoring range to only a range in which data that are going to be transferred are stored.

### Second Exemplary Embodiment

Next, a second exemplary embodiment of the present invention will be described in detail with reference to the accompanying drawings.

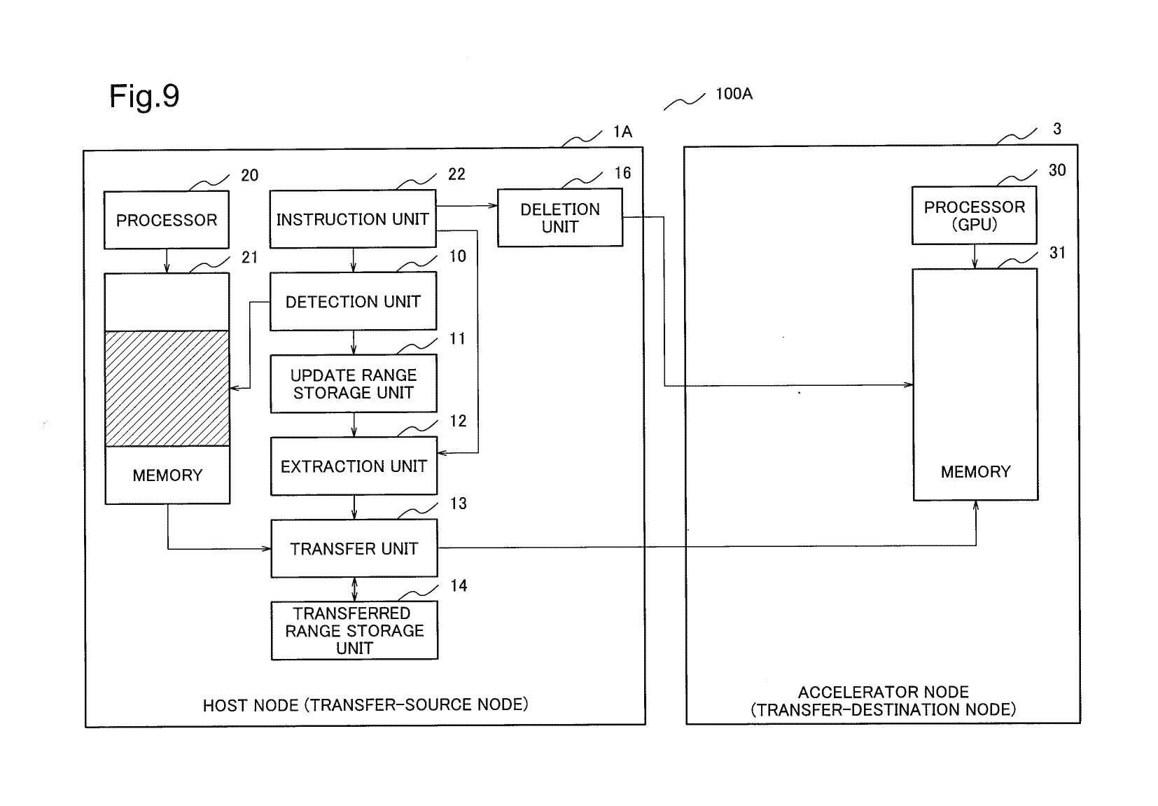

FIG. 9 is a block diagram illustrating a configuration of an information processing system 100A of the present exemplary embodiment.

With reference to FIG. 9, the information processing system 100A includes a host node 1A and an accelerator node 3. In the present exemplary embodiment, the host node 1A is a transfer-source node, and the accelerator node 3 is a transfer-destination node.

In comparing FIG. 9 with FIG. 5, the structure of the information processing system 100A of the present exemplary embodiment and the structure of the information processing system 100 of the first exemplary embodiment are the same except the following differences. A difference between the information processing system 100A and the information processing system 100 is that the information processing system 100A includes the host node 1A, not the host node 1. A difference between the host node 1 and the host node 1A is that the host node 1A includes a transferred range storage unit 14. Further, the host node 1A may include a deletion unit 16.

The transferred range storage unit 14 stores a transferred range which is a range in which data that a transfer unit 13 has transferred from a memory 21 to the accelerator node 3 are stored.

An extraction unit 12 of the present exemplary embodiment extracts, in addition to the range included in the update range within the transfer range, a range not included in the transferred range within the transfer range, as the transfer execution range.

The transfer unit 13 of the present exemplary embodiment, after data transfer has finished, further stores, as the transferred range, a range in which transferred data are stored in the memory 21, in the transferred range storage unit 14.

The deletion unit 16 receives a range in which transferred data are stored in a memory of the transfer-destination node from, for example, an instruction unit 22. In the present exemplary embodiment, the transfer-destination node is the accelerator node 3, and the memory of the transfer-destination node is the memory 31. The deletion unit 16 deletes data stored in the received range in the memory of the transfer-destination node.

Next, an operation of the host node 1A of the present exemplary embodiment will be described in detail with reference to the accompanying drawings.

FIG. 6 is a flowchart illustrating an operation of the host node 1A of the present exemplary embodiment in detecting writing. The operation of the host node 1A of the present exemplary embodiment in detecting writing is the same as the operation of the host node 1A of the first exemplary embodiment.

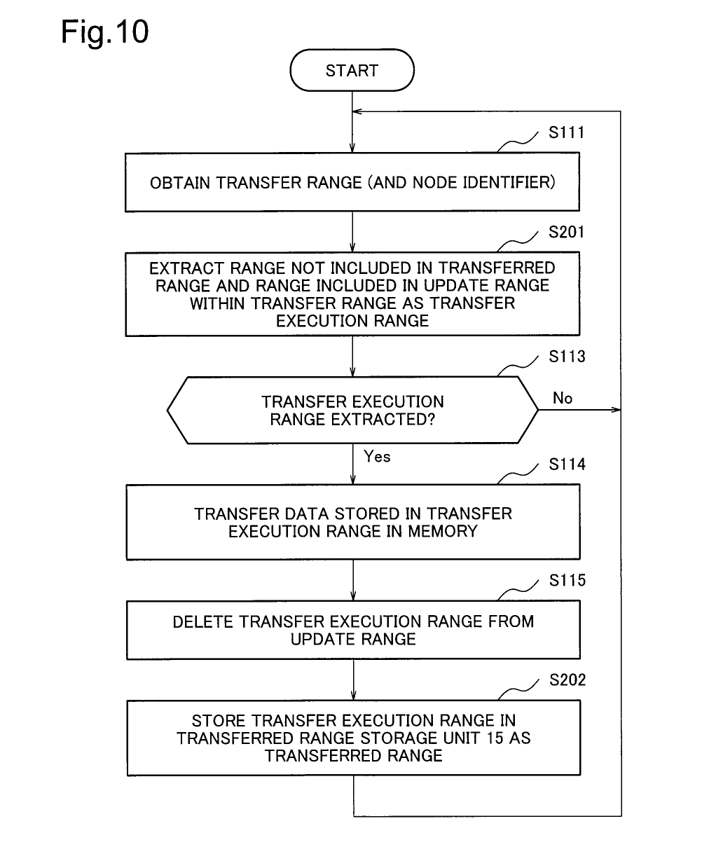

FIG. 10 is a flowchart illustrating an operation of the host node 1A of the present exemplary embodiment in transferring data.

When the accelerator node 3 does not hold data identical to data stored in the memory 21 in starting the operation, the transferred range storage unit 14 does not store any transferred range.

Because operations in steps S111, S113, S114, and S115 illustrated in FIG. 10 are the same as the operations in steps with identical signs in FIG. 8, description thereof will be omitted.

In step S201, the extraction unit 12 extracts, in addition to the range included in the update range within the transfer range, a range not included in the transferred range within the transfer range as the transfer execution range. As described above, when a range which is not included in the monitoring range exist within the transfer range, the extraction unit 12 may also extract the range as the transfer execution range.

The accelerator node 3, which is the transfer-destination node, holds data which are identical to data stored in the memory 21 within a range that is the transferred range, which is stored in the transferred range storage unit 14, excluding the update range. On the other hand, the accelerator node 3 does not hold data stored in a range which is not included in the transferred range, within the transfer range in the memory 21. The extraction unit 12 extracts the range which is not included in the transferred range, within the transfer range, as the transfer execution range.

Data stored in a range which is included in the update range, within the transferred range in the memory 21, have been updated by writing. The extraction unit 12 further extracts the range which is included in the update range, within the transfer range, as the transfer execution range, even if the range is included in the transferred range.

In step S202, the transfer unit 13, after data transfer, stores the transfer execution range, in which the transferred data are stored, in the transferred range storage unit 14, as the transferred range.

After step S202, the operation of the host node 1 returns to step S111. Then, the extraction unit 12 extracts a next transfer range. The extraction unit 12 may, for example, stand by until the instruction unit 22 transmits a transfer range again.

As described above, the host node 1A may include the deletion unit 16 configured to delete transferred data from the transfer-destination node. If such a configuration is employed, the host node 1A of the present exemplary embodiment is capable of suppressing an increase in the amount of data held by the transfer-destination node.

The deletion unit 16 receives a deletion range, which is a range in which deletion target data are stored in the memory 31, from, for example, the instruction unit 22, and deletes data stored in the deletion range from the memory 31. The deletion range may be a storage range of deletion target data, that is, the head address and the data size of a range in which the deletion target data are stored in the memory 31. The deletion range may be the head address and the data size of a range in which data that have been read from the memory 21 and transferred to the accelerator node 3 and are a deletion target in the memory 31 are stored in the memory 21. In this case, the transfer unit 13 may be configured to, when data transfer has finished, associate the transferred range in which the transferred data are stored with the storage range which is a range in which the data are stored in the memory 31, and store the associated ranges in the transferred range storage unit 14. The deletion unit 16 receives, from the instruction unit 22, the transferred range in which data that is a deletion target in the memory 31 and is read from the memory 21 and is transferred to the accelerator node 3 has been stored in the memory 21 at the time of transfer of the data. Then, the deletion unit 16 reads a storage range that is associated with the transferred range from the transferred range storage unit 14. The deletion unit 16 deletes data stored in the read storage range in the memory 31.

The deletion unit 16 may, after deletion of data in the storage range, delete the storage range of the deleted data and the transferred range associated with the storage range from the transferred range storage unit 14.

The present exemplary embodiment described thus far has the same advantageous effects as the first and second advantageous effects of the first exemplary embodiment. Reasons of the advantageous effects are the same as the reasons for the first and second advantageous effects of the first exemplary embodiment.

The present exemplary embodiment has another advantageous effect such that it is also possible to reduce useless data transfer in a case in which the transfer range includes a range in which data that the accelerator node 3 does not hold are stored.

That is because the extraction unit 12 extracts, as the transfer execution range, a range not included in the transferred range within the transfer range in addition to a range included in the update range within the transfer range. With this configuration, the transfer unit 13 is capable of transferring data to which writing has been carried out and data the transfer-destination node does not hold without transferring data the transfer-destination node holds.

### Third Exemplary Embodiment

Next, a third exemplary embodiment of the present invention will be described in detail with reference to the accompanying drawings.

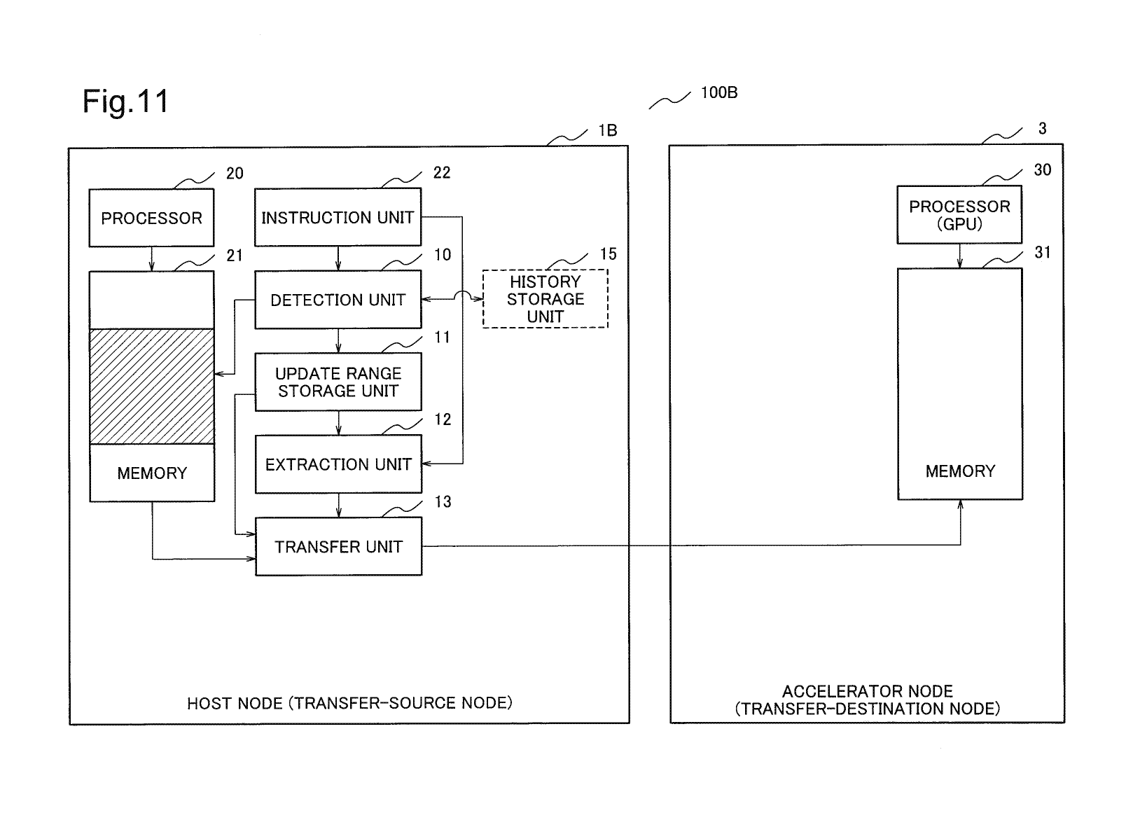

FIG. 11 is a block diagram illustrating a configuration of an information processing system 100B of the present exemplary embodiment.

With reference to FIG. 11, the information processing system 100B includes a host node 1B, a host node 1, and an accelerator node 3. In the present exemplary embodiment, the host node 1B is a transfer-source node, and the accelerator node 3 is a transfer-destination node.

In comparing FIG. 11 with FIG. 5, the configuration of the information processing system 100B of the present exemplary embodiment and the configuration of the information processing system 100 of the first exemplary embodiment are the same except the following differences. A difference between the information processing system 100B and the information processing system 100 is that the information processing system 100B includes the host node 1B, not the host node 1. A difference between the host node 1 and the host node 1B is that the host node 1B may include a history storage unit 15.

When writing into a monitoring range in a memory 21 is detected and the writing meets a preset condition, a detection unit 10 of the present exemplary embodiment excludes, from the monitoring range, a range to which the writing is carried out in the memory 21. When the size of the range for which writing is detected is less than a preset size, for example, the detection unit 10 excludes the range from the monitoring range. Alternatively, when the frequency of writing to the range for which the writing is detected is greater than or equal to a preset frequency, the detection unit 10 excludes the range from the monitoring range. Hereinafter, the range excluded from the monitoring range by the detection unit 10 will be referred to as an exclusion range.

The history storage unit 15 stores a history of writing. The detection unit 10, in detecting writing, updates the history of writing stored in the history storage unit 15. When the detection unit 10 is not configured to exclude the exclusion range from the monitoring range depending on the frequency of writing, the history storage unit 15 may not be included.

When, after the exclusion range is excluded from the monitoring range, the exclusion range is included in the transfer range that a transfer unit 13 receives, the transfer unit 13 transfers data stored in the exclusion range in the memory 21 to the transfer-destination node, regardless of existence or non-existence of writing to the exclusion range in the memory 21.

Next, an operation of the host node 1B of the present exemplary embodiment will be described in detail with reference to the accompanying drawings.

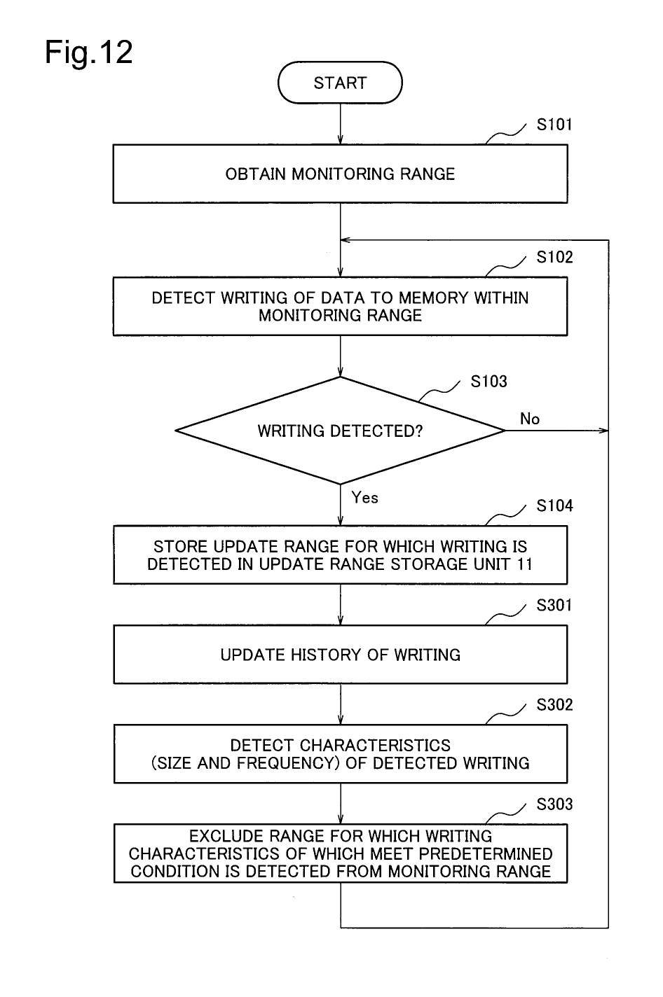

FIG. 12 is a flowchart illustrating operations of the host node 1B of the present exemplary embodiment in detecting writing. Operations from steps S101 to S104 are the same as the operations of the steps with identical signs in FIG. 6.

When the detection unit 10 is configured to detect frequency of writing, the detection unit 10, after the operation in step S104, updates the history of writing stored in the history storage unit 15 (step S301). When the detection unit 10 is not configured to detect frequency of writing, the detection unit 10 does not have to carry out the operation in step S301.

The detection unit 10 stores, in the history storage unit 15, a combination of the head address and the size of a range to which writing is carried out and the date and time when the writing is carried out. Alternatively, the detection unit 10, in detecting writing, may store, in the history storage unit 15, the number of writing operations carried out, for example, after a preset time, with respect to each area.

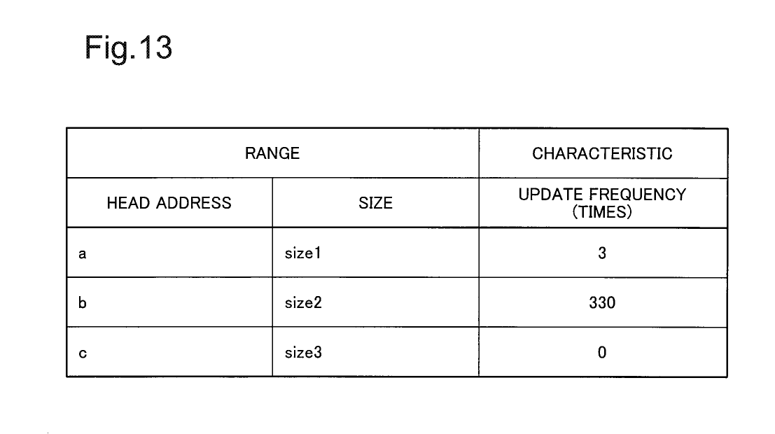

FIG. 13 is a diagram illustrating an example of the history of writing that the history storage unit 15 stores. In the example in FIG. 13, the history storage unit 15 stores numbers of writing operations carried out after the preset time.

Next, the detection unit 10 detects a characteristic of the detected writing (step S302). The characteristic of writing is, for example, the size of data which are written at one time, that is, the size of an area to which the writing is carried out. The characteristic of writing may be the frequency of writing, that is, the frequency of updates with respect to each area to which writing is carried out. The characteristics of writing may be the size of an area to which writing is carried out and the frequency of updates of the area.

The detection unit 10, for example, detects the size of an area to which writing is carried out. Then, when the detected size is less than a preset size, the detection unit 10 excludes the area from the monitoring range. The detection unit 10 may detect the size of the area to which writing is carried out based on, for example, signals from a processor 20 and the memory 21. The detection unit 10 may detect the size of written data by analyzing a write instruction executed by the processor 20.

The detection unit 10 may, for example, detect the frequency of writing with respect to each area in the monitoring range. The detection unit 10 calculates the frequency of writing with respect to each area based on combinations of ranges and dates and times of writing or the number of writing operations stored in the history storage unit 15. The frequency of writing is, for example, the number of writing operations per unit time in the past. The frequency of writing may, for example, be the number of writing operations after the time at which the detection unit 10 is instructed to detect writing by the instruction unit 22.

The preset size and the preset frequency described above may be determined in advance. The detection unit 10 may receive the preset size and the preset frequency described above from the instruction unit 22. The detection unit 10 may carry out both detection of size and measurement of frequency.

Next, the detection unit 10 excludes a range for which writing with a detected characteristic meeting a preset condition is detected from the monitoring range (step S303).

As described above, when the size of an area for which writing is detected is less than a preset size, for example, the detection unit 10 excludes the area from the monitoring range. Alternatively, when the frequency of writing to an area for which the writing is detected is greater than or equal to or less than a preset frequency, for example, the detection unit 10 may exclude the area from the monitoring range. Alternatively, when the size of an area for which writing is detected is less than the preset size and the frequency of writing to the area is greater than or equal to or less than the preset frequency, for example, the detection unit 10 may exclude the area from the monitoring range. The detection unit 10 does not detect writing for the range excluded from the monitoring range thereafter.

Next, an operation of the host node 1B of the present exemplary embodiment in detecting data transfer will be described in detail with reference to the accompanying drawings.

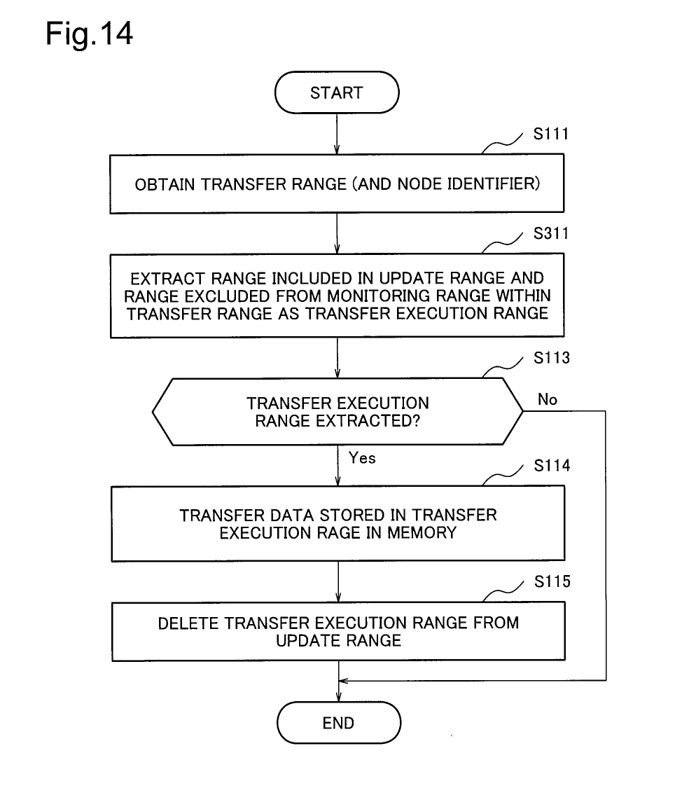

FIG. 14 is a flowchart illustrating operations of the host node 1B of the present exemplary embodiment in detecting data transfer. Operations in the steps except step S311 in FIG. 14 are the same as the operations in the steps with identical signs in FIG. 6.

In step S311, the extraction unit 12 extracts, as a transfer execution range, a range included in the update range and a range excluded from the monitoring range, within the transfer range (step S311).

The extraction unit 12, as described earlier, extracts, as the transfer execution range, a range included in the transfer range but not included in the monitoring range. Therefore, the range excluded from the monitoring range by the detection unit 10 is extracted, by the extraction unit 12, as the transfer execution range.

As described earlier, the transfer unit 13 transfers data stored in the transfer execution range in the memory 21 to the transfer-destination node. Because the range excluded from the monitoring range is included in the transfer execution range, data stored in the range excluded from the monitoring range are transferred to the transfer-destination node by the detection unit 10.

Alternatively, the detection unit 10 may store the exclusion range in the history storage unit 15 or other not-illustrated storage units. The extraction unit 12 may append the exclusion range included in the transfer range to the transfer execution range.

The present exemplary embodiment described thus far has the same advantageous effects as the first exemplary embodiment. Reasons for the advantageous effects are the same as the reasons for the first exemplary embodiment.

Furthermore, the present exemplary embodiment also has an advantageous effect such that it is possible to reduce a load to detect writing.

That is because a range for which writing is detected and the size of which is less than a preset size and a range for which writing is detected and the writing frequency of which is less than a preset frequency, both extracted by the detection unit 10, are excluded from the monitoring range. The detection unit 10 does not detect writing for the range excluded from the monitoring range.

On the other hand, the extraction unit 12 extracts, as the transfer execution range, a range excluded from the monitoring range by the detection unit 10, regardless of existence or non-existence of writing to the range. In consequence, data stored in the range excluded from the monitoring range by the detection unit 10, when the range is included in the transfer range, are transferred regardless of existence or non-existence of writing to the data.

However, when a range the size of which is less than a preset size is excluded from the monitoring range, an increase in a load due to an increase in the amount of transferred data is small because the size of data is small. When a characteristic extracted by the detection unit 10 is frequency and a range the writing frequency of which is greater than or equal to a preset number of times is excluded from the monitoring range, data in the range are transferred often even if the excluded range is a monitoring target. In consequence, an increase in a transfer load due to transfer of data stored in the above-described range, which is excluded from the monitoring range, is small.

The host node 1B may, as with the host node 1A of the second exemplary embodiment, include a transferred range storage unit 14. In that case, in step S311, the extraction unit 12 extracts, as the transfer execution range, a range not included in the transferred range, a range included in the update range, and a range excluded from the monitoring range in combination, within the transfer range. The transfer unit 13 operates in a similar manner to the transfer unit 13 of the second exemplary embodiment.

In this case, the present exemplary embodiment further has the same advantageous effect as the advantageous effect of the second exemplary embodiment. A reason for the advantageous effect is the same as the reason in the second exemplary embodiment.

### Fourth Exemplary Embodiment

Next, a fourth exemplary embodiment of the present invention will be described in detail with reference to the accompanying drawings.

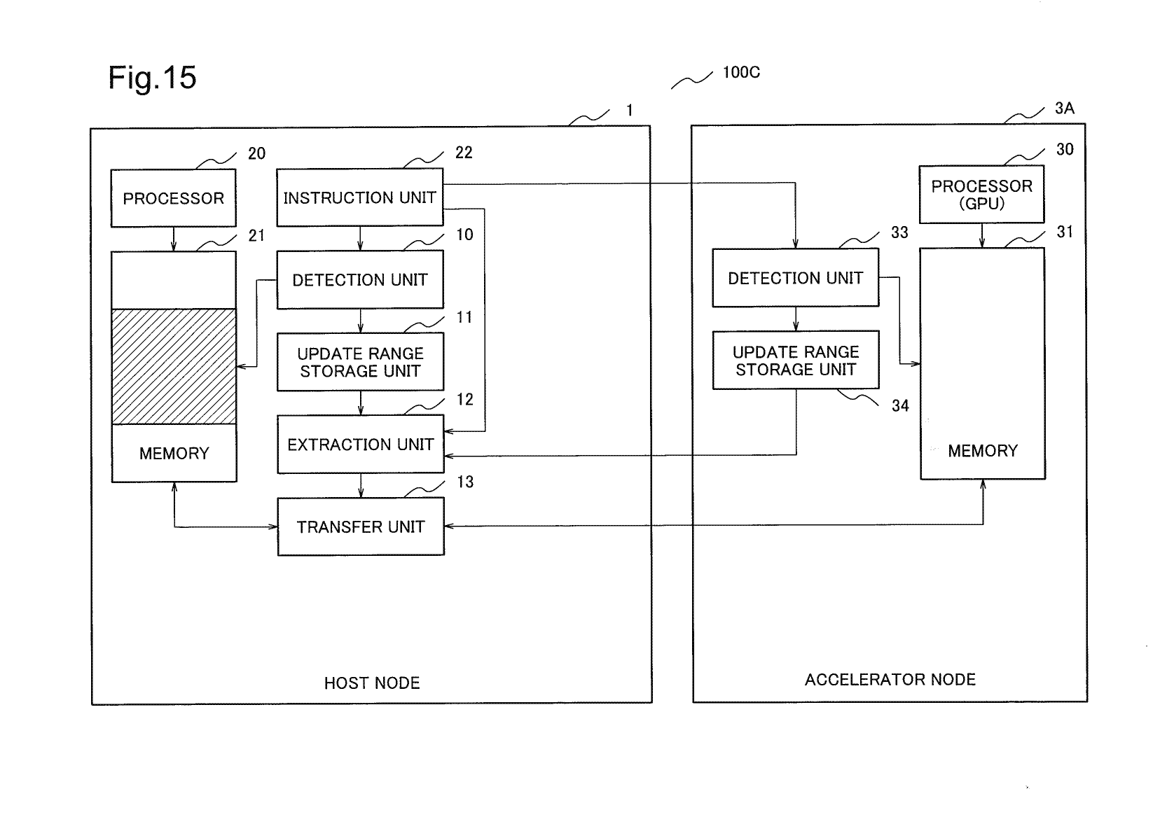

FIG. 15 is a block diagram illustrating a configuration of an information processing system 100C of the present exemplary embodiment.

Respective components of the information processing system 100 of the present exemplary embodiment are the same as the components with the same numbers of the information processing system 100C of the first exemplary embodiment illustrated in FIG. 5. The information processing system 100C illustrated in FIG. 5 includes a host node 1 and an accelerator node 3A. The host node 1, in a similar manner to the host node 1 of the first exemplary embodiment, operates as a transfer-source node as well. The accelerator node 3A, in a similar manner to the accelerator node 3 of the first exemplary embodiment, operates as a transfer-destination node. In the present exemplary embodiment, the accelerator node 3A further operates as a transfer-source node as well. The host node 1 further operates as a transfer-destination node as well.

The accelerator node 3A of the present exemplary embodiment further includes a detection unit 33 and an update range storage unit 34.

An instruction unit 22 further transmits a monitoring range for which writing is detected in a memory 31 to the detection unit 33.

The detection unit 33 detects writing to, for example, the memory 31 within the monitoring range which is received from the instruction unit 22. The detection unit 33 stores a range for which writing is detected in the memory 31 in the update range storage unit 34 as an update range.

The update range storage unit 34 stores the update range, which is a range for which writing is detected, in the memory 31.

Other components of the present exemplary embodiment carry out the same operations as the operations carried out by the components with the same numbers of the first exemplary embodiment illustrated in FIG. 5.

An extraction unit 12 of the present exemplary embodiment further receives a transfer range in the memory 31 from the instruction unit 22. When a plurality of accelerator nodes 3A exist, the extraction unit 12 further receives a node identifier which identifies an accelerator node 3A from the instruction unit 22. The extraction unit 12 extracts, as a transfer execution range in the memory 31, a range included in the monitoring range for which the detection unit 33 detects writing, within the transfer range in the memory 31. When a range not included in the monitoring range in the memory 31 is included in the transfer range in the memory 31, the extraction unit 12 also extracts, as a transfer execution range in the memory 31, the range included in the transfer range but not included in the monitoring range.

A transfer unit 13 further transfers data stored in the extracted transfer execution range in the memory 31 from the accelerator node 3A to a memory 21. When a plurality of accelerator nodes 3A exist, the extraction unit 12 receives the node identifier of an accelerator node 3A. The extraction unit 12 then transfers data stored in the extracted transfer execution range in the memory 31 from the accelerator node 3a identified by the received node identifier to the memory 21.

The instruction unit 22 may transmit, in addition to the transfer range, identification information by which it is possible to decide whether the transfer range is the transfer range in the memory 21 or the memory 31 of the accelerator node 3A, to the extraction unit 12. The extraction unit 12 may determine whether to transmit data to the accelerator node 3A or from the accelerator node 3A, depending on the identification information.

Next, operations of the host node 1 and the accelerator node 3A of the present exemplary embodiment will be described in detail with reference to the accompanying drawings.

FIG. 6 is a flowchart illustrating operations of the host node 1 of the present exemplary embodiment in detecting writing.

FIG. 8 is a flowchart illustrating operations of the host node 1 of the present exemplary embodiment in transferring data.

Operations of the host node 1 in a case in which the host node 1 is a transfer-source node and the accelerator node 3A is a transfer-destination node are the same as the operations in the first exemplary embodiment described earlier.

Next, operations in a case in which the accelerator node 3A is a transfer-source node and the host node 1 is a transfer-destination node will be described. Description of the operations in this case is equivalent to the description of the operations of the first exemplary embodiment except that the detection unit 10, the update range storage unit 11, and the memory 21 are replaced with the detection unit 33, the update range storage unit 34, and the memory 31, respectively.

FIG. 8 is a flowchart illustrating operations of the accelerator node 3A of the present exemplary embodiment in detecting writing.

A difference from the operations of the host node 1 of the first exemplary embodiment is that the detection unit 33, not the detection unit 10, detects writing to the memory 31, not the memory 21. The detection unit 33 stores the update range in the update range storage unit 34, not the update range storage unit 11.

In the present exemplary embodiment, the host node 1 holds data identical to data stored in the memory 31 within the monitoring range, except data stored in the memory 31 within the update range, which is stored in the update range storage unit 34.

For example, when the detection unit 33 starts detecting writing, data stored in the memory 31 within the monitoring range may be transferred to the host node 1 in advance. In that case, the update range storage unit 34 does not store any update range. Alternatively, when the detection of writing starts, the update range storage unit 34 may store, as an update range, a range in which data that the host node 1 does not hold are stored within the monitoring range in the memory 31, in advance.

In step S101, the detection unit 33 obtains the monitoring range in the memory 31.

In step S102, the detection unit 10 carries out detection of writing to the memory 31. The detection unit 10 detects writing to the monitoring range in the memory 31 as an update range.

FIG. 8 is a flowchart illustrating operations of the host node 1 of the present exemplary embodiment in transferring data.

A difference from the operation of the host node 1 of the first exemplary embodiment is that the extraction unit 12 reads the update range from the update range storage unit 34, not the update range storage unit 11. In the present exemplary embodiment, the transfer unit 13 transfers data stored in the transfer execution range in the memory 31, not the memory 21, to the memory 21, not the accelerator node 3.

In step S111, the extraction unit 12 obtains the transfer range in the memory 31.

When a plurality of accelerator nodes 3A exist, in step S111, the extraction unit 12 obtains the node identifier of an accelerator node 3A, which is the transfer-source node. In this case, the instruction unit 22 transmits the node identifier of the accelerator node 3A, which is the transfer-source node, to the extraction unit 12. When the accelerator node 3A, which is the transfer-source node, is specified as in a case in which the information processing system 100C includes only one accelerator node 3A, the extraction unit 12 does not have to obtain the node identifier of the accelerator node 3A, which is the transfer-source node.

In step S112, the extraction unit 12 extracts the transfer execution range in the memory 31.

In step S114, the transfer unit 13 transmits data stored in the transfer execution range in the memory 31 to the memory 21 of the transfer-destination node.

The present exemplary embodiment described thus far has the same advantageous effects as the advantageous effects of the first exemplary embodiment. The present exemplary embodiment also has the same advantageous effects as the advantageous effects of the first exemplary embodiment when the transfer-destination node is the host node 1 and the transfer-source node is the accelerator node 3A. Reasons for the advantageous effects are the same as the reasons for the advantageous effects of the first exemplary embodiment.

The host node 1 of the present exemplary embodiment has a similar structure to the structure of the host node 1A of the second exemplary embodiment illustrated in FIG. 9, and may thus carry out similar operations to the operations of the host node 1A. In that case, when data are transferred from the memory 31 to the memory 21, the host node 1 of the present exemplary embodiment may carry out similar operations to the operations carried out by the host node 1A the detection unit 10, the update range storage unit 11, and the memory 21 of which are replaced with the detection unit 33, the update range storage unit 34, and the memory 31, respectively. The host node 1 of the present exemplary embodiment has a similar configuration to the operations of the host node 1B of the above-described third exemplary embodiment illustrated in FIG. 11, and may thus carry out similar operations to the operations of the host node 1B. In that case, when data are transferred from the memory 31 to the memory 21, the host node 1 of the present exemplary embodiment may carry out similar operations to the operations of the host node 1B the detection unit 10, the update range storage unit 11, and the memory 21 of which are replaced with the detection unit 33, the update range storage unit 34, and the memory 31, respectively.

### Fifth Exemplary Embodiment

Next, a fifth exemplary embodiment of the present invention will be described in detail with reference to the accompanying drawings.

The present exemplary embodiment is configured based on a communication model in which data transfer is instructed on both nodes which are involved in the data transfer, not on an offload model in which one node instructs data transfer. In this communication model, in order to complete a data transfer, a transmission operation needs to be instructed on a transfer-source node of the data transfer and a reception operation needs to be instructed on a transfer-destination node. Such a communication model is, for example, employed in a socket communication library, which is used in an interprocess communication, TCP/IP (Transmission Control Protocol/Internet Protocol), or the like. Such a communication model is a general communication model for those skilled in the art.

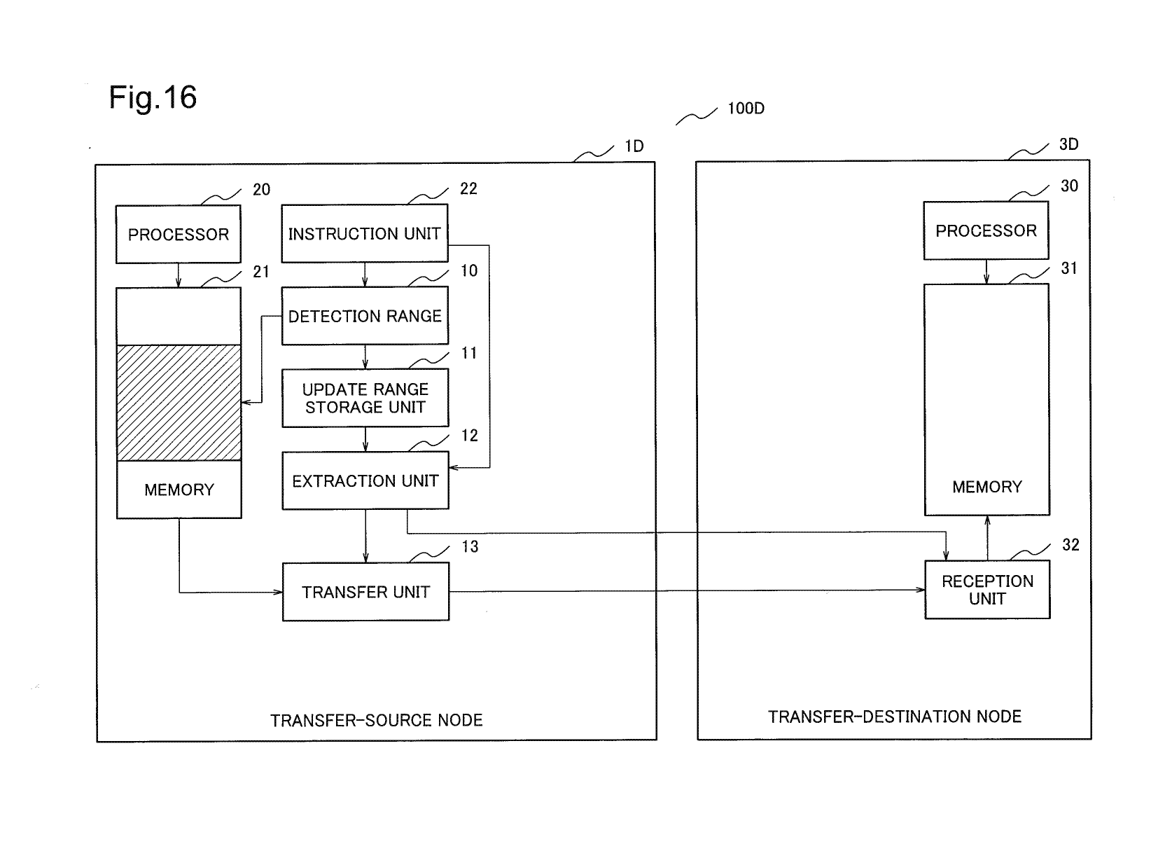

FIG. 16 is a block diagram illustrating an example of a configuration of an information processing system 100D of the present exemplary embodiment. The information processing system 100D includes a transfer-source node 1D and a transfer-destination node 3D, which are interconnected by a not-illustrated communication network 4.

In the present exemplary embodiment, the transfer-destination node 3D includes, in addition to the configuration of the accelerator node 3 in FIG. 5, a reception unit 32.

The transfer-source node 1D operates in a similar manner to the host node 1 of the first exemplary embodiment. The transfer-destination node 3D operates in a similar manner to the accelerator node 3 of the first exemplary embodiment.

In the present exemplary embodiment, respective nodes have no distinction between a host node and an accelerator node. The respective nodes may have both configurations of a transfer-source node and a transfer-destination node. In that case, the respective nodes operate as a transfer-source node or a transfer-destination node depending on a direction of data transfer.

Next, operations of the present exemplary embodiment will be described in detail with reference to the accompanying drawings.

A host node 1 of the present exemplary embodiment operates in a similar manner to the operations of the host node 1 of the first exemplary embodiment illustrated in FIGS. 6 and 8.

However, when data transfer is carried out, a transfer unit 13 instructs a reception unit 32 to receive data. The reception unit 32 carries out reception of data only when an instruction of data reception is received.

The host node 1 of the present exemplary embodiment has the same configuration as the host node 1A of the second exemplary embodiment, and may carry out similar operations to the host node 1A. The host node 1 of the present exemplary embodiment has the same configuration as the host node 1B of the third exemplary embodiment, and may carry out similar operations to the host node 1B. However, in both cases, the transfer unit 13 instructs the reception unit 32 to receive data when data transfer is carried out.

The present exemplary embodiment has the same advantageous effects as the first exemplary embodiment. Reasons for the advantageous effects are the same as the reasons for the first exemplary embodiment.

The present exemplary embodiment, as with the first exemplary embodiment, has an advantageous effect such that it is also possible to reduce useless data transfer on the above-described communication model of the present exemplary embodiment. A reason for the advantageous effect is that the transfer unit 13 transmits an instruction to carry out data reception to the reception unit 32.

### Sixth Exemplary Embodiment

Next, a sixth exemplary embodiment of the present invention will be described in detail with reference to the accompanying drawings.

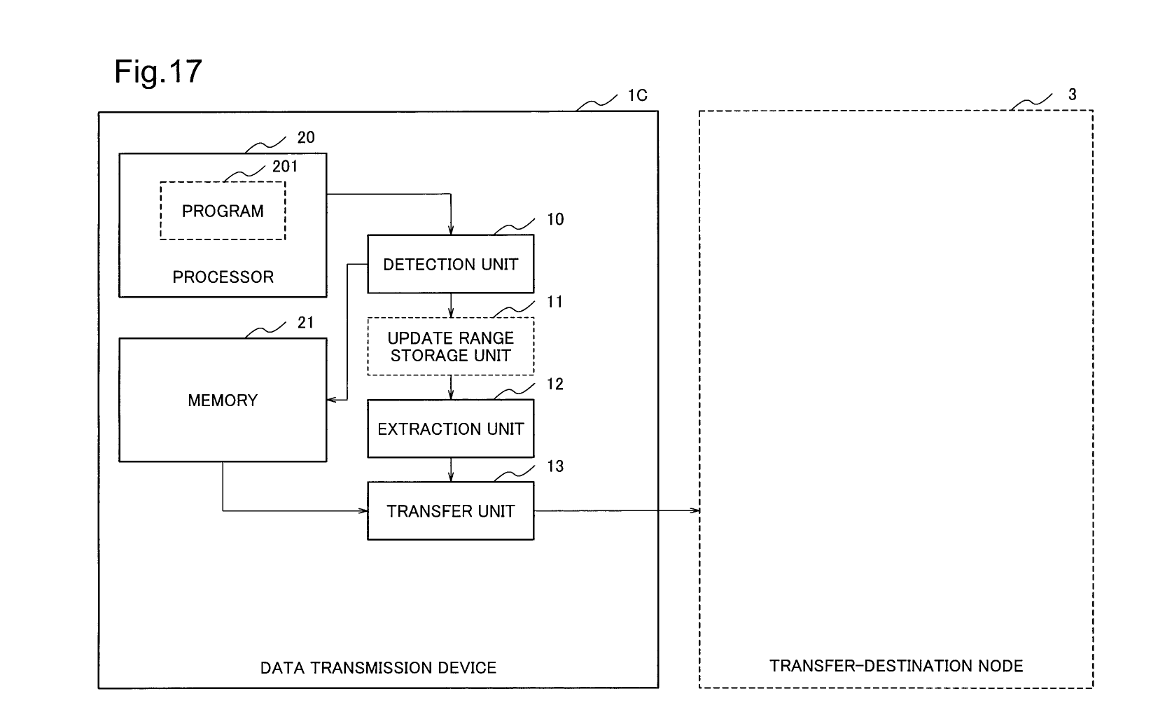

FIG. 17 is a block diagram illustrating a configuration of a data transmission device 1C of the present exemplary embodiment.

With reference to FIG. 17, the data transmission device 1C of the present exemplary embodiment includes a memory 21, a processor 20, a detection unit 10, an extraction unit 12, and a transfer unit 13. The processor 20 carries out writing to the memory 21. The detection unit 10 detects writing to the memory in which data that a transfer-destination node 3 holds are stored, and identifies an update range which is a range for which writing is detected in the memory. The extraction unit 12, in response to receiving, from the processor 20, a transfer instruction which specifies a transfer range in the memory 21, extracts, as a transfer execution range, a range included in the update range within the received transfer range. The transfer unit 13 carries out data transfer to transfer data stored in the transfer execution range in the memory 21 to the transfer-destination node 3.

The present exemplary embodiment described thus far has the same advantageous effects as the first exemplary embodiment. Reasons for the advantageous effects are the same as the reasons for the advantageous effects of the first exemplary embodiment.

It is possible to implement the host node 1 by a computer and a program to control the computer, dedicated hardware, or a combination of a computer and a program to control the computer and dedicated hardware. It is possible to implement the host node 1A by a computer and a program to control the computer, dedicated hardware, or a combination of a computer and a program to control the computer and dedicated hardware. It is possible to implement the host node 1B by a computer and a program to control the computer, dedicated hardware, or a combination of a computer and a program to control the computer and dedicated hardware. It is possible to implement the data transmission device 1C by a computer and a program to control the computer, dedicated hardware, or a combination of a computer and a program to control the computer and dedicated hardware. It is possible to implement the transfer-source node 1D by a computer and a program to control the computer, dedicated hardware, or a combination of a computer and a program to control the computer and dedicated hardware. It is possible to implement the accelerator node 3 by a computer and a program to control the computer, dedicated hardware, or a combination of a computer and a program to control the computer and dedicated hardware. It is possible to implement the accelerator node 3A by a computer and a program to control the computer, dedicated hardware, or a combination of a computer and a program to control the computer and dedicated hardware. It is possible to implement the transfer-destination node 3D by a computer and a program to control the computer, dedicated hardware, or a combination of a computer and a program to control the computer and dedicated hardware.

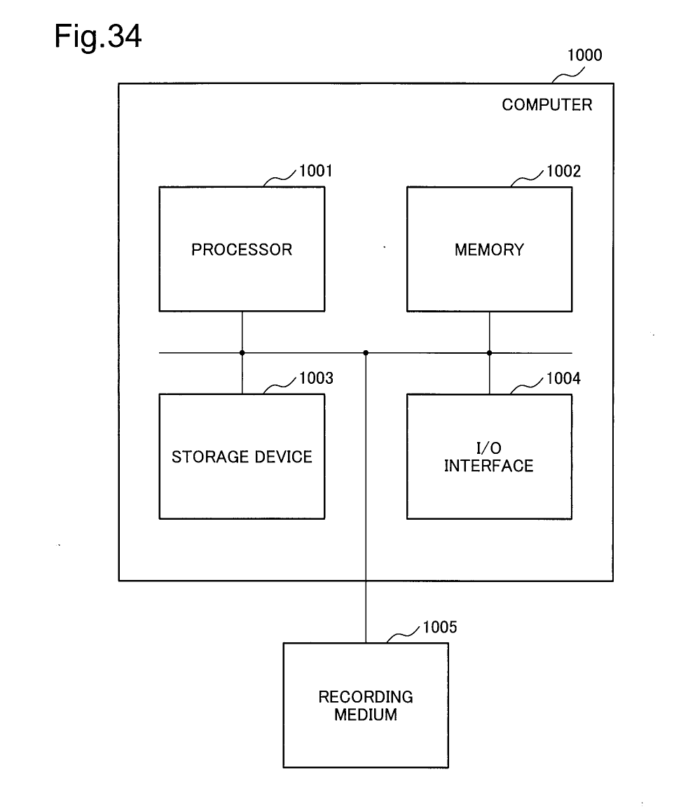

FIG. 34 is a diagram illustrating an example of a configuration of a computer 1000. The computer 1000 is used to implement the host node 1, the host node 1A, the host node 1B, the data transmission device 1C, the transfer-source node 1D, the accelerator node 3, the accelerator node 3A, and the transfer-destination node 3D. With reference to FIG. 34, the computer 1000 includes a processor 1001, a memory 1002, a storage device 1003, and an I/O (Input/Output) interface 1004. The computer 1000 is capable of accessing a recording medium 1005. The memory 1002 and the storage device 1003 are, for example, storage devices, such as a RAM (Random Access Memory) and a hard disk. The recording medium 1005 is, for example, a storage device, such as a RAM and a hard disk, a ROM (Read Only Memory), or a portable recording medium. The storage device 1003 may be the recording medium 1005. The processor 1001 is capable of reading and writing data and a program from/to the memory 1002 and the storage device 1003. The processor 1001 is capable of accessing, for example, a transfer-destination node or a transfer-source node via the I/O interface 1004. The processor 1001 is capable of accessing the recording medium 1005. In the recording medium 1005, a program which makes the computer 1000 operate as the host node 1 is stored. Alternatively, in the recording medium 1005, a program which makes the computer 1000 operate as the host node 1A is stored. Alternatively, in the recording medium 1005, a program which makes the computer 1000 operate as the host node 1B is stored. Alternatively, in the recording medium 1005, a program which makes the computer 1000 operate as the data transmission device 1C is stored. Alternatively, in the recording medium 1005, a program which makes the computer 1000 operate as the transfer-source node 1D is stored. Alternatively, in the recording medium 1005, a program which makes the computer 1000 operate as the accelerator node 3 is stored. Alternatively, in the recording medium 1005, a program which makes the computer 1000 operate as the accelerator node 3A is stored. Alternatively, in the recording medium 1005, a program which makes the computer 1000 operate as the transfer-destination node 3D is stored.

The processor 1001 loads a program stored in the recording medium 1005 into the memory 1002. As described above, the program makes the computer 1000 operate as the host node 1, the host node 1A, the host node 1B, the data transmission device 1C, the transfer-source node 1D, the accelerator node 3, the accelerator node 3A, or the transfer-destination node 3D. The processor 1001 executing a program loaded into the memory 1002 makes the computer 1000 operate as the host node 1. Alternatively, the processor 1001 executing a program loaded into the memory 1002 makes the computer 1000 operate as the host node 1A. Alternatively, the processor 1001 executing a program loaded into the memory 1002 makes the computer 1000 operate as the host node 1B. Alternatively, the processor 1001 executing a program loaded into the memory 1002 makes the computer 1000 operate as the data transmission device 1C. Alternatively, the processor 1001 executing a program loaded into the memory 1002 makes the computer 1000 operate as the transfer-source node 1D. Alternatively, the processor 1001 executing a program loaded into the memory 1002 makes the computer 1000 operate as the accelerator node 3. Alternatively, the processor 1001 executing a program loaded into the memory 1002 makes the computer 1000 operate as the accelerator node 3A. Alternatively, the processor 1001 executing a program loaded into the memory 1002 makes the computer 1000 operate as the transfer-destination node 3D.

It is possible to implement the detection unit 10, the extraction unit 12, the transfer unit 13, the deletion unit 16, the instruction unit 22, and the reception unit 32 by, for example, dedicated programs, which is loaded into the memory 1002 from the recording medium 1005 to store programs, to achieve functions of the respective units and the processor 1001 to execute the dedicated programs. It is possible to implement the update range storage unit 11, the transferred range storage unit 14, and the history storage unit 15 by the storage device 1003, such as the memory included in the computer and the hard disk device.

It is also possible to implement a portion or the whole of the detection unit 10, the update range storage unit 11, the extraction unit 12, the transfer unit 13, the transferred range storage unit 14, the history storage unit 15, the deletion unit 16, the instruction unit 22, and the reception unit 32 by dedicated circuits to achieve functions of the respective units.

### First Configuration Example

Next, specific configuration examples of the respective exemplary embodiments of the present invention will be described in detail with respect to the accompanying drawings.

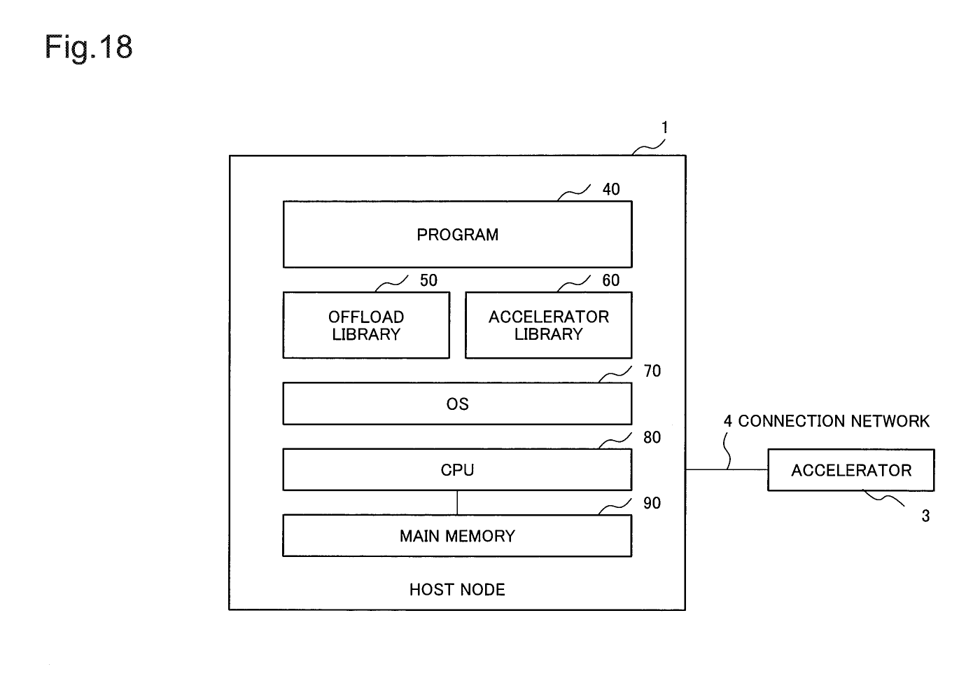

FIG. 18 is a diagram illustrating a summary of an information processing system 100 of the first configuration example of the present invention. In the configuration example illustrated in FIG. 18, the offload model is used.

In the example illustrated in FIG. 18, a host node 1 includes a main memory 90 and a CPU (Central Processing Unit) 80. The CPU 80 executes an OS (Operating System) 70. The CPU 80 executes an offload library 50 and an accelerator library 60 on the OS 70. The CPU 80 further executes a program 40 which uses the offload library 50 and the accelerator library 60. The host node 1 and an accelerator 3 are interconnected by a connection network 4, which is a communication line. The accelerator 3 is the above-described accelerator node 3.

The offload library 50 is a library that has a function to carry out specific processing in the accelerator 3. The offload library 50 is, for example, a library that has a function to execute various matrix operations in the accelerator 3. The accelerator library 60 is a library which provides low-level functions to use the accelerator 3. The accelerator library 60, for example, has a function to allocate a memory of the accelerator 3 and a function to transfer data between the memory of the accelerator 3 and the memory of the host node 1. Examples of such libraries include a library that a GPU maker provides as a library for a GPU. The present configuration example is an example of a case in which the offload library 50 encapsulates a call of the accelerator 3 from the program 40. That is, an instruction of data transfer to the accelerator 3 and a call of processing in the accelerator 3 are executed in the offload library 50.

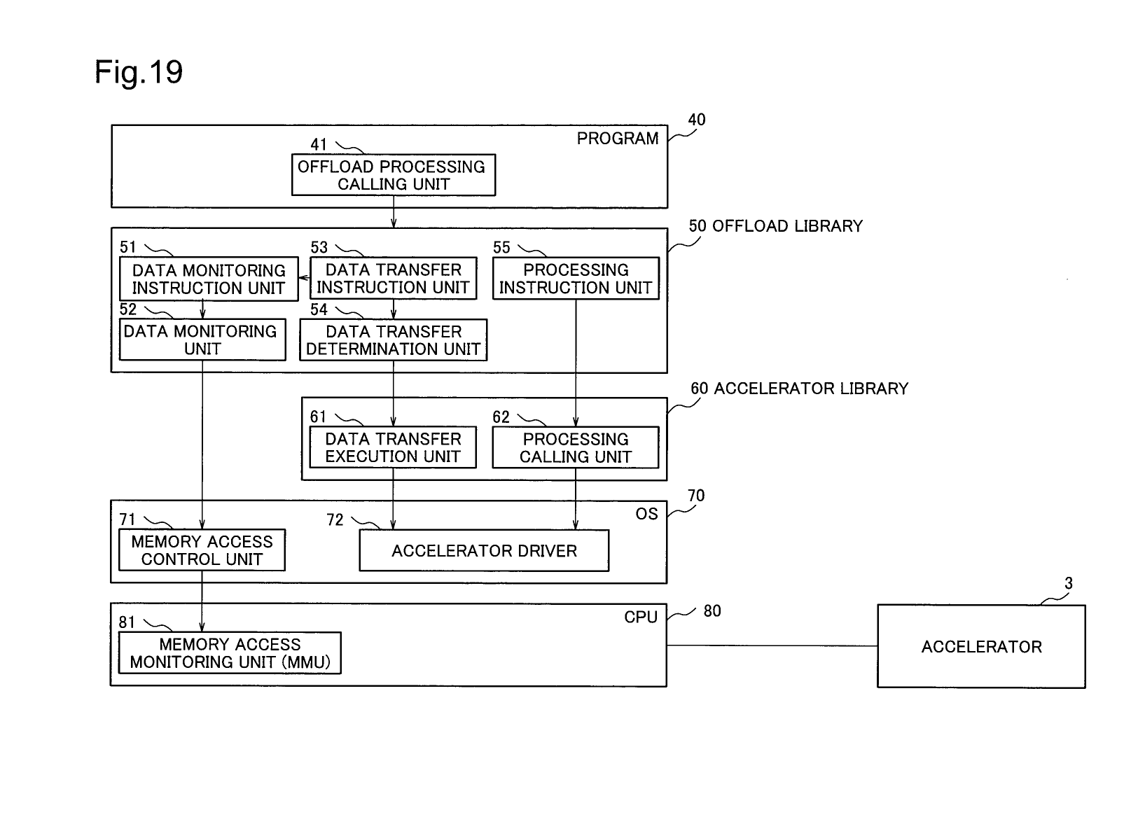

FIG. 19 is a diagram illustrating a detailed configuration of the host node 1. The CPU 80 of the host node 1 of the present configuration example executes the OS 70, the accelerator library 60, the offload library 50, and the program 40.

In the present configuration example in FIG. 19 and diagrams illustrating a configuration of each configuration example described below, the host node 1 and the main memory 90 included in the host node 1 are omitted, that is, not illustrated. The OS 70 and the CPU 80 are included in the not-illustrated host node 1. The program 40 and respective libraries are executed by the CPU 80 of the host node 1. The CPU 80 may execute a plurality of programs 40 at the same time.

In the respective configuration examples of the present invention, respective sections that the programs and the libraries have represent functional blocks that the programs or the libraries in which the sections are included have. The CPU 80 which is controlled by the programs and libraries operates as the respective sections the programs and the libraries include. In the following description, operations of the CPU 80 which is controlled by the programs and the libraries will be described as operations of the programs and the libraries.

The program 40 has an offload processing calling unit 41. The offload processing calling unit 41 has a function that, in carrying out processing that a library provides, calls a library function that carries out the processing. The offload library 50 includes a data transfer instruction unit 53, a data transfer determination unit 54, a data monitoring instruction unit 51, a data monitoring unit 52, and a processing instruction unit 55. The accelerator library 60 includes a data transfer execution unit 61 and a processing calling unit 62. Although these libraries may include other functions, description of functions that do not have direct relations to the present invention is omitted. The OS 70 includes a memory access control unit 71 and an accelerator driver 72. The CPU 80 includes a memory access monitoring unit 81. The memory access monitoring unit 81 is implemented by an MMU (Memory Management Unit). The memory access monitoring unit 81 is also referred to as an MMU 81.

Correspondences between components of the present configuration example and components of the respective exemplary embodiments described above are as follows. The data transfer instruction unit 53 operates as the instruction unit 22. The data transfer determination unit 54 operates as the extraction unit 12. The data monitoring unit 52 operates as the detection unit 10. The data monitoring instruction unit 51 and the data monitoring unit 52 operate as the detection unit 10 of the third exemplary embodiment. The data transfer execution unit 61 operates as the transfer unit 13. The CPU 80 is the processor 20. The main memory 90 is the memory 21. The main memory 90 operates as the update range storage unit 11, the transferred range storage unit 14, and the history storage unit 15. An update range stored in the update range storage unit 11 may be represented in tabular form as a data update table. A set of update ranges stored in the update range storage unit 11 will be hereinafter referred to as a data update table 91. A transferred range stored in the transferred range storage unit 14 may be represented in tabular form as a transfer data table. A set of transferred ranges stored in the transferred range storage unit 14 will be referred to as a transfer data table. The update range storage unit 11, the transferred range storage unit 14, the history storage unit 15, the data update table 91, and the transfer data table are omitted in FIG. 19.

The processing instruction unit 55 has a function to specify processing that the accelerator 3 carry out and instruct the accelerator 3 to carry out the processing. The processing calling unit 62 has a function to receive an instruction from the processing instruction unit 55 and actually make the accelerator 3 carry out the processing.

Next, the data monitoring unit 52 of the present configuration example will be described.

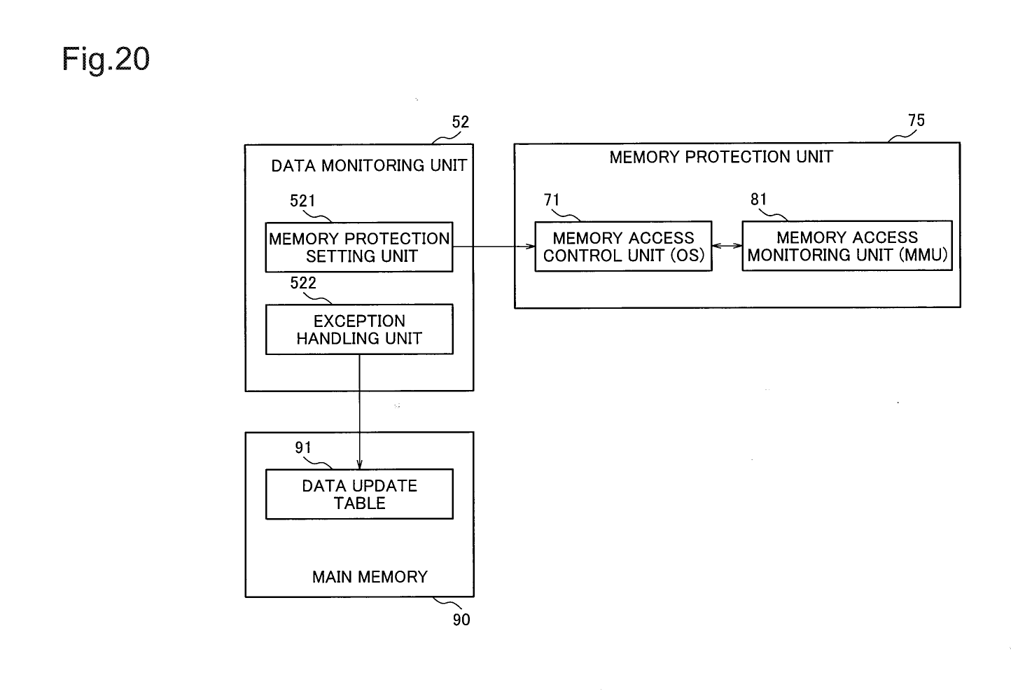

FIG. 20 is a diagram illustrating a configuration of the data monitoring unit 52 of the present configuration example. The data monitoring unit 52 of the present configuration example includes a memory protection setting unit 521 and an exception handling unit 522. The data monitoring unit 52, by using the memory access control unit 71 of the OS 70 and the MMU 81 of the CPU 80, monitors access to data. A combination of the memory access control unit 71 of the OS 70 and the MMU 81 of the CPU 80 is a memory protection unit 75 in FIG. 20. The data update table 91 is stored in the main memory 90. Alternatively, the data monitoring unit 52 may store the data update table 91.

The MMU 81 monitors memory access carried out by the CPU 80. The MMU 81 is designed to cause an exception in the MMU 81 when an access that violates an access right with respect to each page of a memory, which is described in a page table, is carried out. The MMU 81 is widely-used hardware having such a function. In general, when an exception is caused, an exception handler of the OS 70 is called and the exception handler of the OS 70 calls a signal handler of the program 40. These components and functions are implemented by a conventional method. For example, these components and functions are installed in general CPUs and OSes.

The memory protection setting unit 521 calls the memory access control unit 71 of the OS 70 so that the access right to a page in which monitoring target data are stored is set to be read-only. For example, it is known that an access right can be set by using a function “mprotect”, which is a function to control the protection attribute of a memory page and is implemented in some OSes.

The exception handling unit 522 is a signal handler which is called when an access right violation is caused. When the exception handling unit 522 is called, the exception handling unit 522 identifies data which have been written based on an address at which the access violation is caused. Then, the exception handling unit 522 changes the data update table 91 so that the data update table 91 indicates that the identified data is updated. The exception handling unit 522 also changes the access right of a page, in which the monitoring target data are stored, to be writable. With this processing, the data monitoring unit 52 makes the program 40 carry out the same operation as an operation in a case in which data monitoring is not carried out.

Next, by using an example of specific processing, operations of the present configuration example will be described.

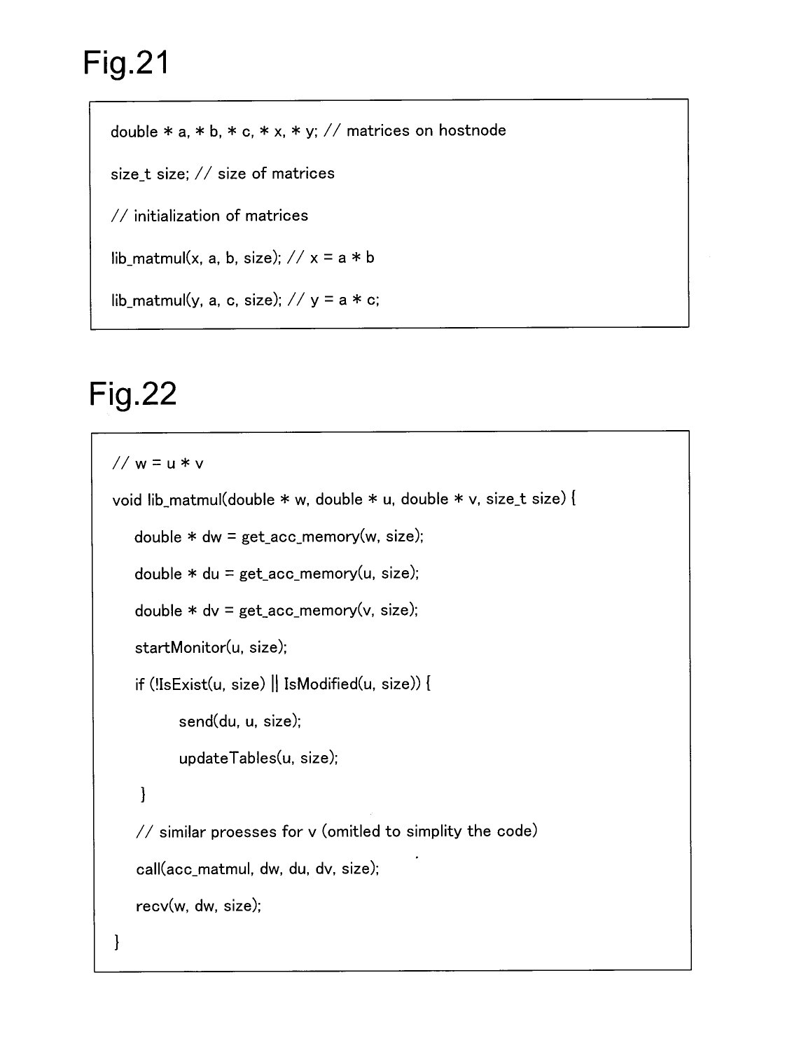

FIG. 21 is an example of the program 40 of the present configuration example. The program 40 of the present configuration example is a program that carries out two matrix multiplication operations x=a*b and y=a*c, where a, b, c, x, and y are matrices.

FIG. 22 is an example of a function to carry out multiplication which is included in the offload library 50 of the present configuration example. A function “lib_matmul” in FIG. 22 is an example of a function to carry out matrix multiplication in the accelerator 3. This function, with respect to addresses, which is received via an argument, of respective matrices in the memory of a host, obtains addresses of matrices, corresponding to the respective matrices, in the memory of the accelerator 3 by calling a function “get_acc_memory”. When the matrices are not allocated to the memories of the accelerator 3, the function “get_acc_memory” allocates memory areas to the matrices and returns the addresses of the allocated memory areas. When memory areas are already allocated to the matrices, the function “get_acc_memory” returns the addresses of the memory areas.

Next, the function “lib_matmul” calls a function “startMonitor” to issue an instruction to monitor data access to a matrix u. This processing is equivalent to the data monitoring unit 52 specifying the whole of a memory area in which the matrix u is stored as a monitoring target and starting detection of writing.

Next, the function “lib_matmul” checks whether or not the matrix b is transmitted to the accelerator 3 by using a function “IsExist”, and checks whether or not the matrix b is modified on the host by using a function “IsModified”. These functions carry out the checks by using the transfer data table and the data update table 91, respectively. At least either in a case in which the matrix b is not transmitted or in a case in which the matrix b is modified, the function “lib_matmul” calls a function “send” to instruct data transmission. After data transmission, the function “lib_matmul” calls a function “updateTables” to update the transfer data table and the data update table 91. The function “send” is a function that the accelerator library 60 provides. The function “lib_matmul” further carries out the same processing for a matrix v. In the example illustrated in FIG. 22, description of the processing for the matrix v is omitted.

Then, the function “lib_matmul” calls a function “call” and instructs carrying out multiplication processing on the accelerator 3. This instruction corresponds to an operation of the processing instruction unit 55. Thereafter, the function “lib_matmul” receives a result of the multiplication from the accelerator 3 by using a function “recv”. The functions “call” and “recv” are functions that the accelerator library 60 provides.

In the description of the present configuration example, detailed description of functions that the accelerator library 60 includes is omitted. The functions “send”, “recv”, and “call”, described above, may be implemented by any conventional implementation method. These functions do not always need to be implemented by software functions. These functions may be implemented by directives or the like.

Next, the data update table 91 and the transfer data table in the operations of the present configuration example will be described.

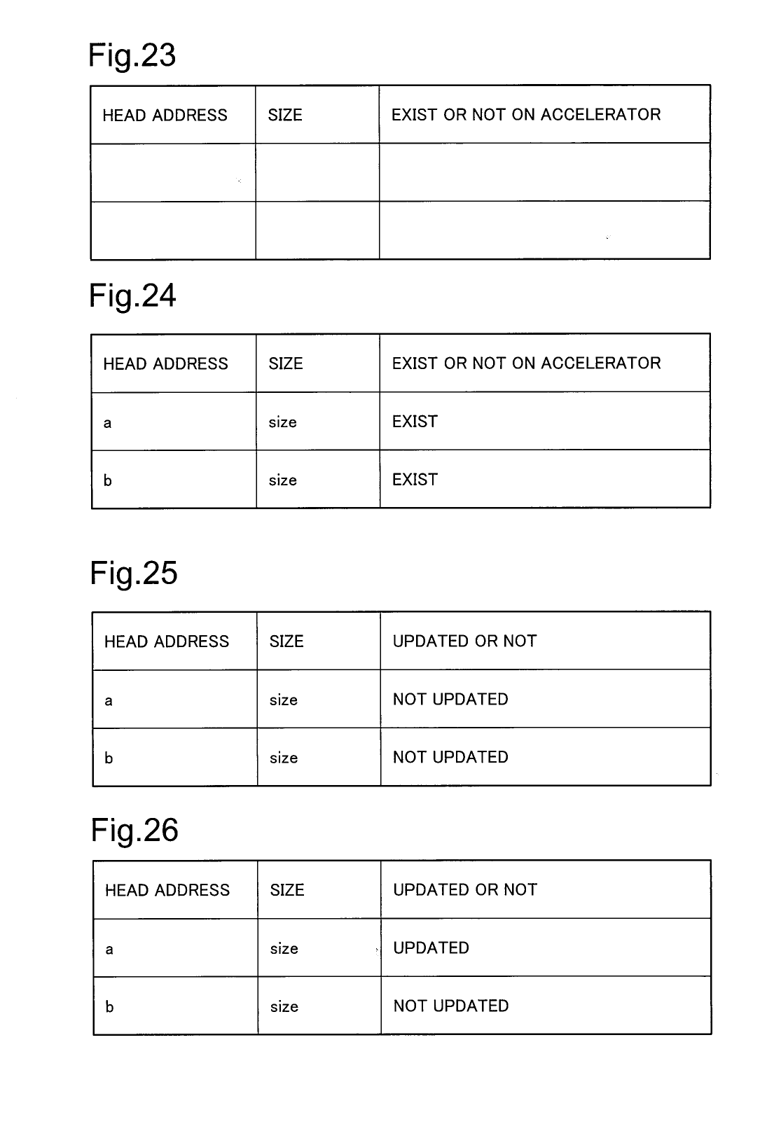

FIG. 23 is a diagram illustrating the transfer data table in an initial state when the program 40 first executes the function “lib_matmul”. Because data transfer is not carried out yet when the transfer data table is in this state, the transfer data table does not have any data therein. Thus, in a first call of the function “lib_matmul”, both matrices a and b are transmitted to the accelerator 3.

FIG. 24 is a diagram illustrating the transfer data table that is updated after the matrices a and b are transmitted. FIG. 25 is a diagram illustrating the data update table 91 that is updated after the matrices a and b are transmitted. To the transfer data table, the transmitted matrices a and b are added in a state indicating that data thereof exist in the accelerator 3. To the data update table 91, the matrices a and b are added in a state indicating that data thereof have not been updated in the host node 1.

When the program 40 executes the second function “lib_matmul” illustrated in FIG. 21, it is shown, by referring to the transfer data table, that the matrix a exists and the matrix c does not exist in the accelerator 3. By referring to the data update table 91, it also shown that the matrix a is not updated. Thus, only the matrix c is transferred. Furthermore, after the transfer of the matrix c, the transfer data table and the data update table 91 are updated. States of the tables after update are obvious and description thereof will thus be omitted.

As described above, when two functions which use the common matrix a are called successively as in the case, illustrated in FIG. 21, in which the function “lib_matmul” is called twice successively, the matrix a is not transferred in the second call of the function if the matrix a has not been modified between the two functions. In consequence, it is possible to reduce useless data transfer.

On the other hand, when writing to the matrix a is carried out between calls of two functions which use the matrix a, the data monitoring unit 52 changes the data update table 91 as illustrated in FIG. 26. Thus, the matrix a is also transferred in the processing of the second call of the function “lib_matmul” after the writing to the matrix a is carried out. Therefore, in the processing of the second call of the function “lib_matmul”, correct calculation is carried out because multiplication is carried out by using the updated data.

FIG. 26 is a diagram illustrating the data update table 91 that is updated after writing to the matrix a is carried out.

In the data update table 91 and a data transfer table of the present configuration example, a memory area is specified by using the address and the size thereof with respect to each matrix. A memory area may be specified, for example, with respect to each page. In this case, the data transfer determination unit 54 decides whether or not to transfer a memory area specified with respect to each page. When only a part of a matrix is updated, only a page including the updated part is transferred. In other words, when only a part of a matrix is updated, a page which does not include the updated part is not transferred. In consequence, it is possible to further reduce the amount of transferred data.

The present configuration example described thus far is a case in which a host node 1 and an accelerator 3 are included. However, a plurality of either host nodes 1 or accelerators 3 or both host nodes 1 and accelerators 3 may be included. When a plurality of host nodes 1 are included, each of the host nodes 1 includes a data update table 91 and a transfer data table. When a plurality of accelerator nodes 3 are included, the function “lib_matmul”, which operates as the data transfer execution unit 61, records whether or not data exist in each of the accelerators 3, separately for each of the accelerators 3 in the transfer data table.

### Second Configuration Example

Next, a second configuration example of the present invention will be described.

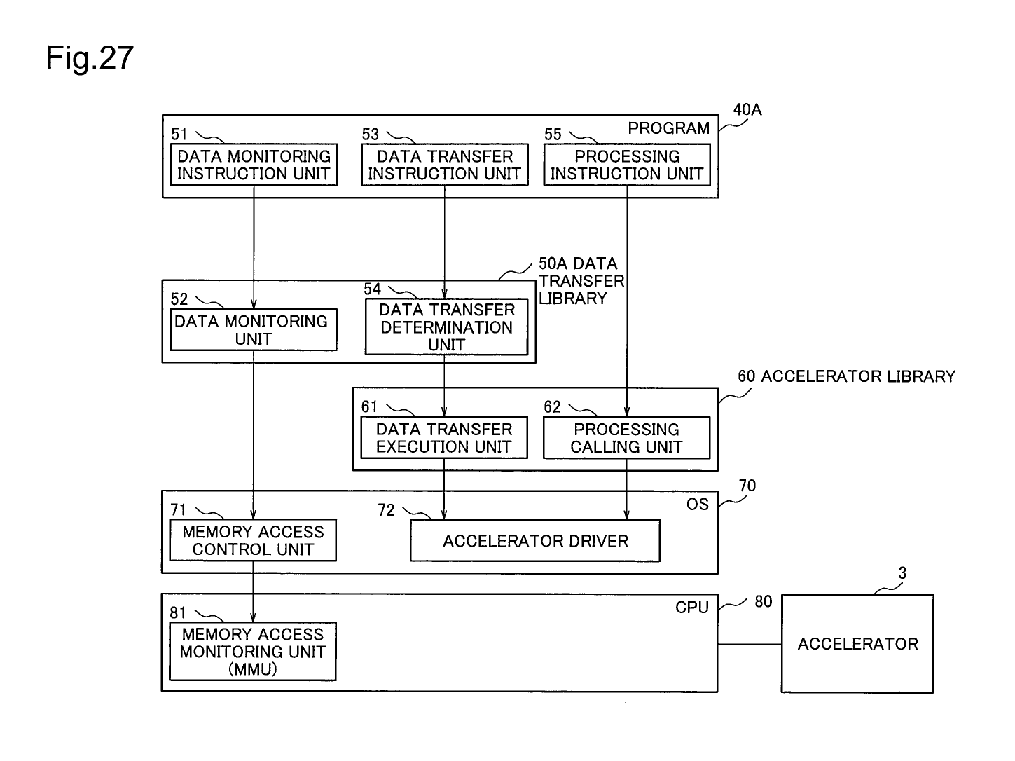

FIG. 27 is a diagram illustrating a configuration of the present configuration example. A CPU 80 of a host node 1 of the present configuration example executes an OS 70, an accelerator library 60, a data transfer library 50A, and a program 40A. In the present configuration example, the program 40A includes a data transfer instruction unit 53, a data monitoring instruction unit 51, and a processing instruction unit 55. The data transfer library 50A includes a data transfer determination unit 54 and a data monitoring unit 52. Configurations of the accelerator library 60, the OS 70, and the CPU 80 are the same as those of the first configuration example. Functions of the respective components are the same as those of the first configuration example.

In the present configuration example, the program 40A calls a processing calling unit 62 of the accelerator library 60 by specifying processing to be carried out on an accelerator. On the other hand, in transferring data, the program 40A uses the data transfer library 50A without directly calling a data transfer execution unit 61 of the accelerator library 60. In the present configuration example, unlike the first configuration example, processing that the host node 1 makes an accelerator 3 execute is not limited to processing carried out by functions provided by the offload library 50. The present configuration example has the same advantageous effects as the advantageous effects of the first configuration example. In the present configuration example, the program 40A is further capable of making the accelerator 3 carry out arbitrary processing.

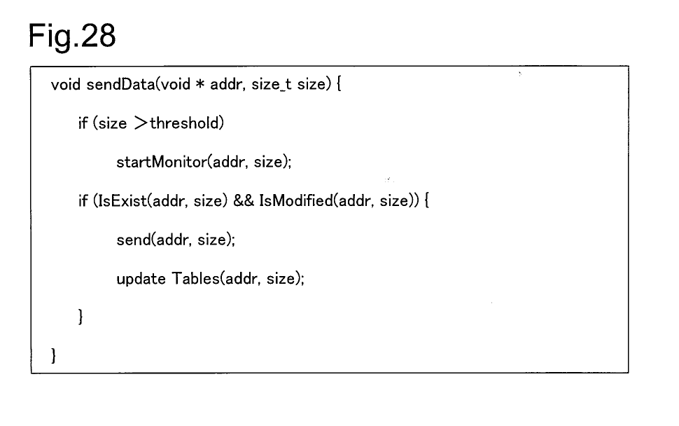

FIG. 28 is a diagram illustrating an example of a data transmission function provided by the data transfer library 50A of the present configuration example. A function “sendData” in FIG. 28 is an example of the data transmission function provided by the data transfer library 50A of the present configuration example. Arguments of the function “sendData” are the address and the size of data to be transferred. First, the function “sendData” instructs the data monitoring unit 52 to carry out monitoring when the size of data is greater than a threshold value. This operation corresponds to an operation of the data monitoring instruction unit 51. Next, the function “sendData” determines whether or not to transmit data by looking up a data update table 91 and a transfer data table. When it is determined that data is transmitted, the function “sendData” calls a data transfer execution unit 61 and updates both tables.

### Third Configuration Example

Next, a third configuration example of the present invention will be described.

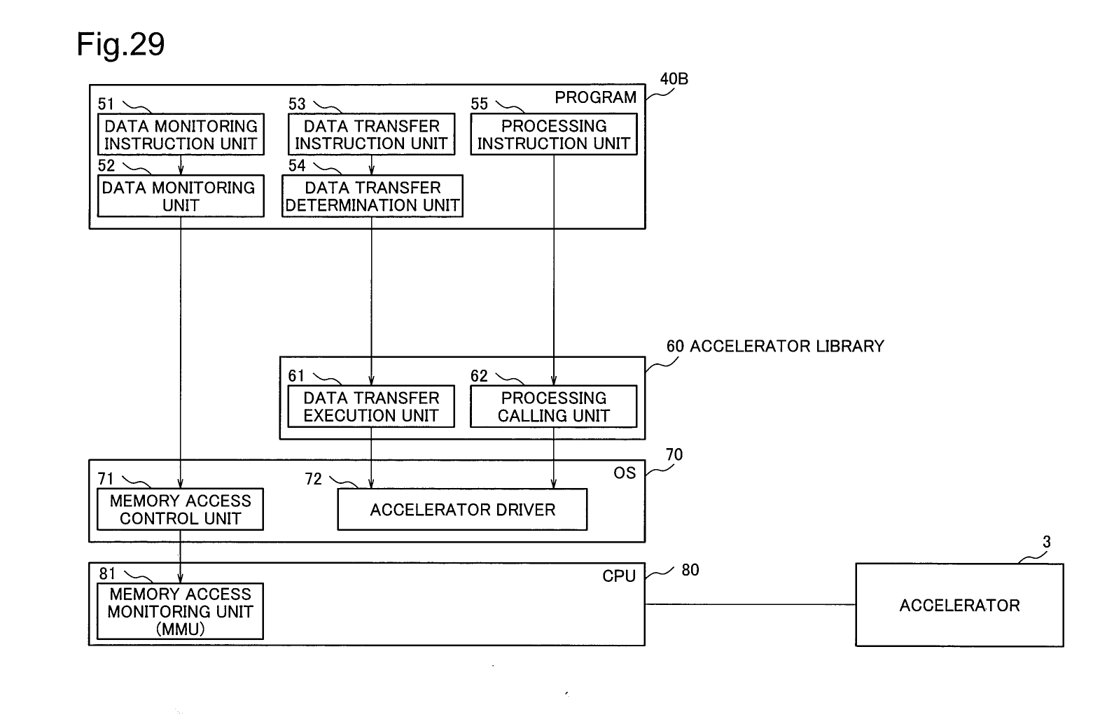

FIG. 29 is a diagram illustrating a configuration of the present configuration example. A CPU 80 of a host node 1 of the present configuration example executes an OS 70, an accelerator library 60, and a program 40B. In the present configuration example, the program 40B includes a data transfer instruction unit 53, a data transfer determination unit 54, a data monitoring instruction unit 51, a data monitoring unit 52, and a processing instruction unit 55. Configurations of the accelerator library 60, the OS 70, and the CPU 80 are the same as those of the first configuration example. Functions of the respective components are the same as those of the first configuration example.

The present configuration example has the same advantageous effects as the advantageous effects of the first configuration example. In the present configuration example, the program 40B is further capable of carrying out data transfer and processing in an accelerator 3 without using a library other than the accelerator library 60.

### Fourth Configuration Example

Next, a fourth configuration example of the present invention will be described.

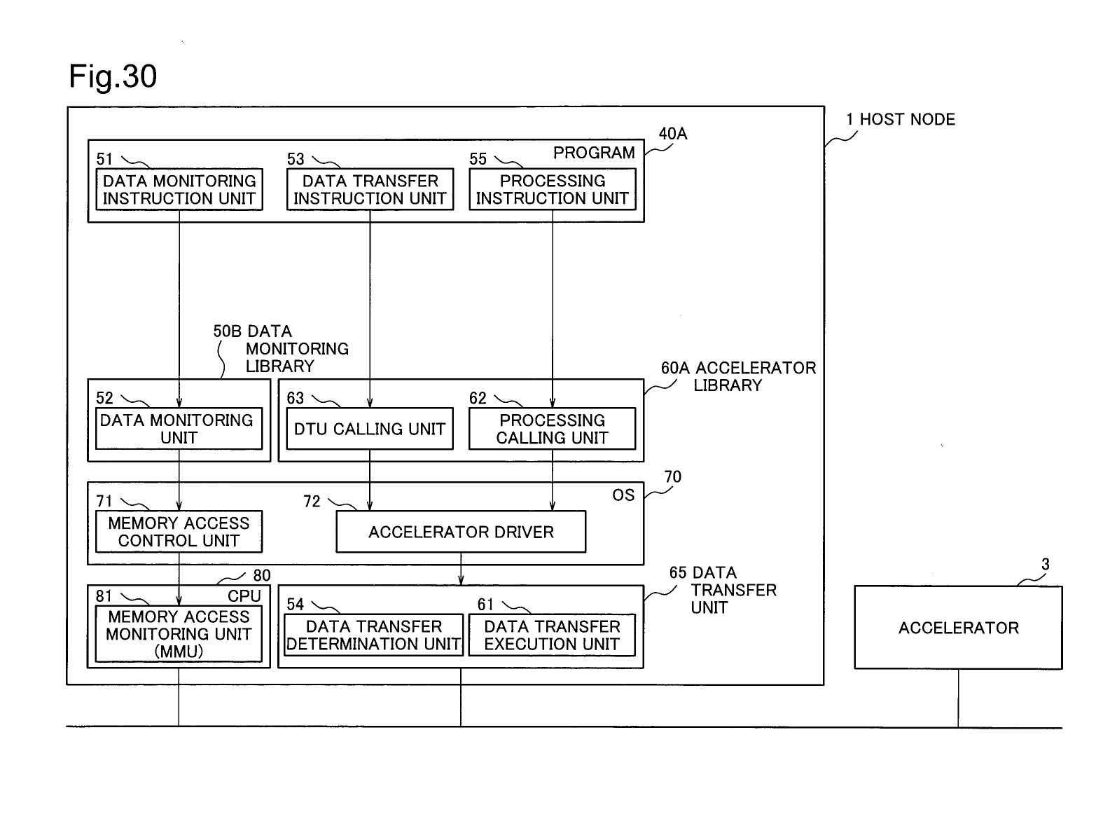

FIG. 30 is a diagram illustrating a configuration of the present configuration example. A CPU 80 of a host node 1 of the present configuration example executes an OS 70, an accelerator library 60A, a data monitoring library 50B, an a program 40A. The data monitoring library 50B includes a data monitoring unit 52. The accelerator library 60A includes a processing calling unit 62 and a DTU (Data Transfer Unit) calling unit 63. The host node 1 of the present configuration example includes a data transfer unit 65. In the present configuration example, the data transfer unit 65 includes a data transfer determination unit 54 and a data transfer execution unit 61. Configurations of the OS 70 and the CPU 80 are the same as those of the first configuration example. Functions of the respective components are the same as those of the first configuration example.

The data transfer unit 65 is hardware that has a function to transfer data between nodes. The data transfer unit 65 transfers data without using the CPU 80. The data transfer unit 65 transferring data makes it possible to reduce a CPU load for data transfer. Therefore, such a data transfer unit 65 is widely used. In general, the data transfer unit 65 has a function to transfer specified data. The data transfer unit 65 of the present configuration example, by further including the data transfer determination unit 54, transfers data only when the data have been updated.

A typical operation of the present configuration example in transferring data will be described below.

1. The program 40A instructs the accelerator library 60A to transfer data.

2. The DTU calling unit 63 of the accelerator library 60A instructs an accelerator driver 72 to carry out data transfer by using the data transfer unit 65. The accelerator driver 72 calls the data transfer unit 65.

3. The data transfer determination unit 54 of the data transfer unit 65, referring to a data update table 91, determines existence or non-existence of a data update. The data transfer determination unit 54, only when data is updated, calls the data transfer execution unit 61 and transfers the data.

It is preferable that the data transfer operation is carried out only when data already exist at a transfer-destination. That is because, when data is not updated, data transfer is not carried out. A method to determine whether or not data have already been transmitted in the present configuration example may be the same as the determination method in the configuration examples described earlier.

In the present configuration example, to reduce data transfer, it is preferable that a data monitoring instruction unit 51 instructs the data monitoring unit 52 to monitor writing to data to be transferred. It is preferable that the data monitoring unit 52 monitors writing to data to be transferred. That is because writing to data not monitored is not recorded in the data update table 91. Data not monitored, regardless of existence or non-existence of writing to the data, are certainly transferred.

Although the data update table 91 is omitted in FIG. 30, the data update table 91 may be arranged in a main memory 90. In this case, the data transfer unit 65 refers to the data update table 91 arranged in the main memory 90. The data transfer unit 65 may store the data update table 91.

In the present configuration example, the program 40A includes a data transfer instruction unit 53, a processing instruction unit 55, and the data monitoring instruction unit 51. The data transfer instruction unit 53, the processing instruction unit 55, and the data monitoring instruction unit 51 may, as with the first configuration example and the second configuration example, be included in an offload library 50 or a data transfer library 50A.

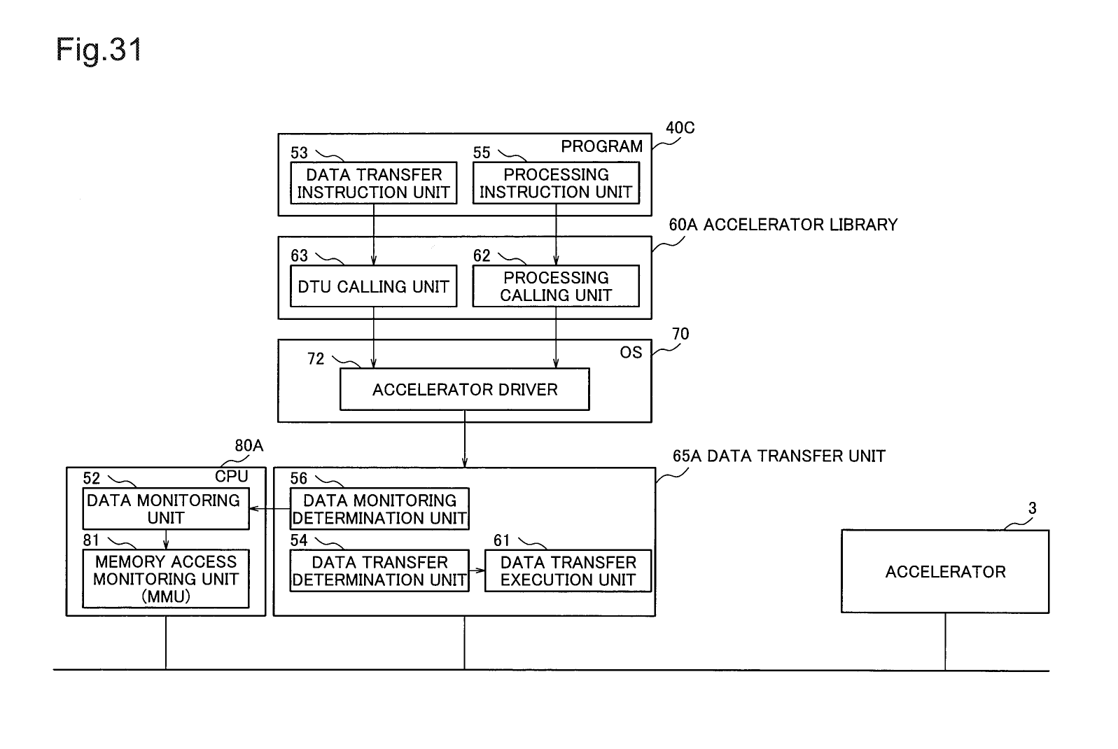

FIG. 31 is a diagram illustrating an example of another embodiment of the present configuration example. In the example in FIG. 31, the host node 1, in addition to a CPU 80A and the main memory 90, includes a data transfer unit 65A. The CPU 80A of the host node 1 executes the OS 70, an accelerator library 60, and a program 40C. The program 40C includes the data transfer instruction unit 53 and the processing instruction unit 55. The CPU 80A includes a memory access monitoring unit 81 and the data monitoring unit 52. The data transfer unit 65A includes a data monitoring determination unit 56, the data transfer determination unit 54, and the data transfer execution unit 61. The accelerator library 60A is the same as the accelerator library 60A illustrated in FIG. 30. The OS 70 is the same as the OS 70 illustrated in FIG. 30. However, the OS 70 of the present embodiment does not have to include the data monitoring unit 52.

In the present configuration example, as in the example in FIG. 31, the data transfer unit 65A may include the data monitoring determination unit 56. In this case, the data monitoring determination unit 56 included in the data transfer unit 65A calls the data monitoring unit 52 and instructs the data monitoring unit 52 to monitor data. Thus, the program 40C and respective libraries do not have to have functions of the data monitoring instruction unit 51.

### Fifth Configuration Example

Next, a fifth configuration example of the present invention will be described.

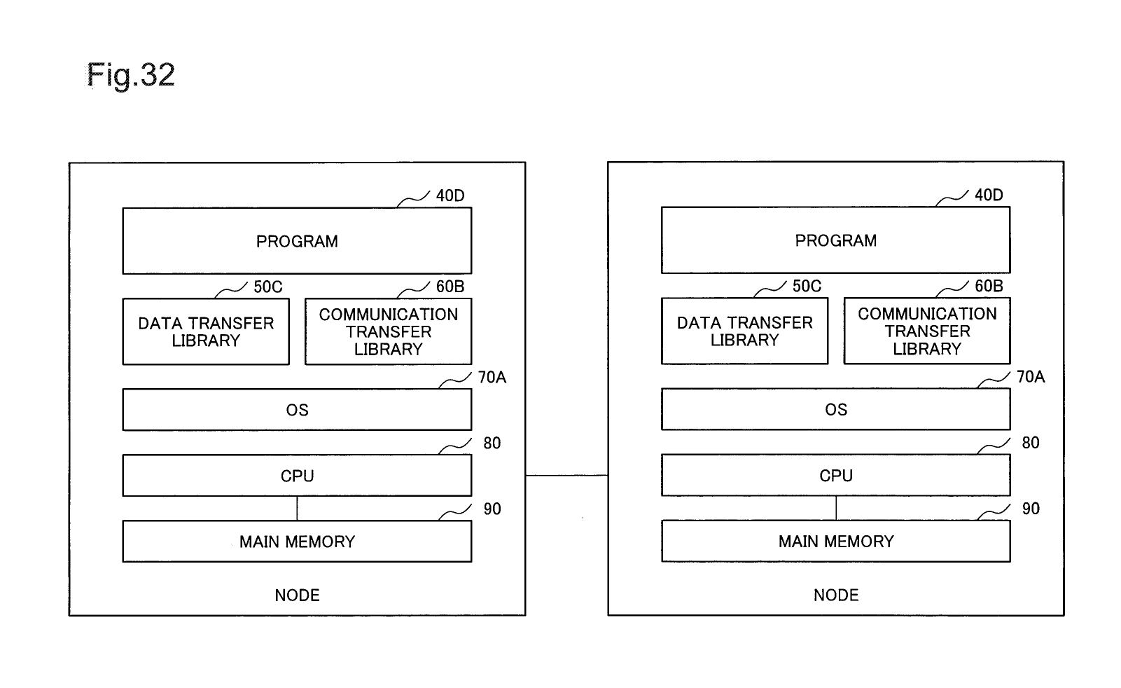

FIG. 32 is a diagram illustrating a summary of a configuration of the present configuration example. The present configuration example is a configuration example based on the fifth exemplary embodiment. With reference to FIG. 32, in the present configuration example, a plurality of nodes having an identical configuration are interconnected. In transferring data, one node transmits data and the other node receives the data. The node transmitting the data operates as a transfer-source node 1D described earlier. The node receiving the data operates as a transfer-destination node 3D described earlier.

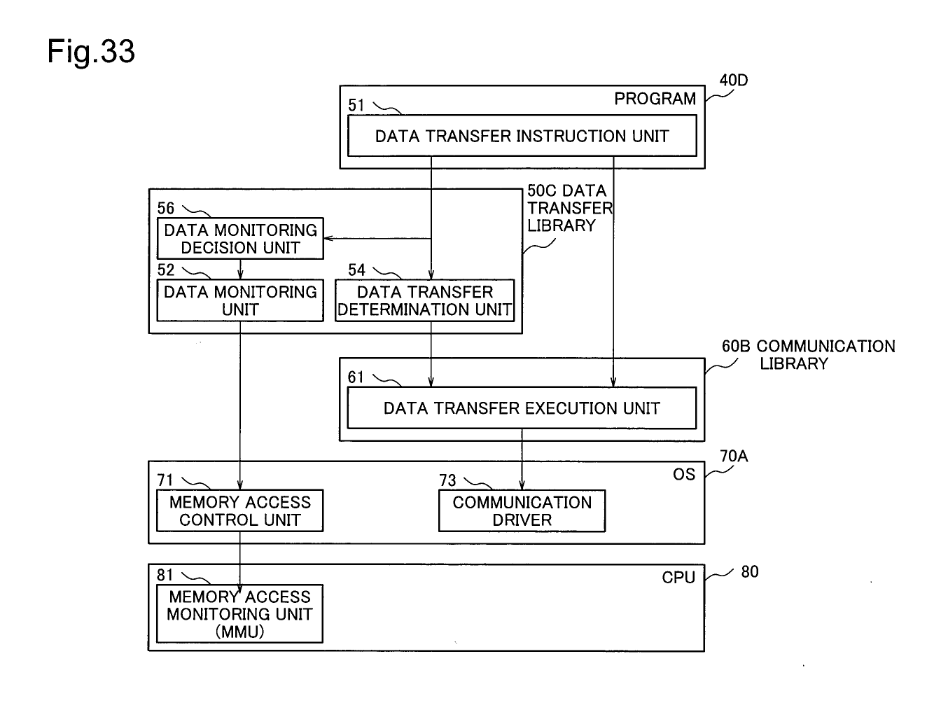

FIG. 33 is a diagram illustrating a detailed configuration of each node of the present configuration example. A CPU 80 of the present configuration example executes an OS 70A, a communication library 60B, a data transfer library 50C, and a program 40D. The OS 70A includes a memory access control unit 71 and a communication driver 73. The communication library 60B includes a data transfer execution unit 61. The data transfer library 50C includes a data monitoring determination unit 56, a data monitoring unit 52, and a data transfer determination unit 54. The data transfer library 50C, for example, includes a data reception unit which operates as the reception unit 32 described above and is not illustrated in FIG. 33.

The present configuration example, unlike the other configuration examples, includes the communication library 60B. The communication library 60B is a library to carry out two-way (transmission and reception) communication. The data transfer execution unit 61 in the communication library 60B has a function to transmit data and a function to receive data. Other components are the same as the components with the identical numbers of the other configuration examples and, thus, description thereof will be omitted.

The data transfer determination unit 54 of the present configuration example, when it is determined that data transfer is carried out, calls data transfer execution unit 61 of the communication library 60B and makes the data transfer execution unit 61 carry out the data transfer. When it is determined that data transfer is not carried out, the data transfer determination unit 54 also calls the data transfer execution unit 61 and makes the data transfer execution unit 61 transmit a message, to a transfer-destination node, informing that data transfer is not carried out. This is because the message is necessary for a data reception unit, which receives data, of the transfer-destination node to know that no data is transmitted.

Each of the nodes of the present configuration example includes the data transfer library 50C, which includes the data transfer determination unit 54, in the configuration in FIG. 33. Each of the nodes may, as the host node 1 in other configuration examples, include an offload library 50 including the data transfer determination unit 54, or the program 40D may include the data transfer determination unit 54.

All or part of the exemplary embodiments described above may be described as in the following Supplementary Notes, but the present invention is not limited thereto.

(Supplementary Note 1)

A data transmission device, including:

a memory;

a processor that carries out writing to the memory;

detection means for detecting writing to the memory and storing an update range, which is a range for which writing is detected in the memory, in update range storing means;

the update range storing means;

extraction means for receiving, from the processor, a transfer instruction which specifies a transfer range in the memory and, at every reception, extracting, as a transfer execution range, a range included in the update range within the received transfer range; and

transfer means for carrying out data transfer to transfer data stored in the transfer execution range in the memory to a transfer-destination node.

(Supplementary Note 2)

The data transmission device according to Supplementary Note 1, wherein

the detection means receives, from the processor, a detection range which is a range for which writing is detected in the memory, and detects writing to the memory within the detection range, and

the extraction means, in addition to the transfer execution range, extracts, as the transfer execution range, a range which is not included in the detection range, within the transfer range.

(Supplementary Note 3)

The data transmission device according to Supplementary Note 2, wherein

the extraction means receives the transfer instruction two or more times, and

the detection means, in a case of a size of the detected update range being less than a preset size, excludes the update range from the detection range thereafter.

(Supplementary Note 4)

The data transmission device according to Supplementary Note 2 or 3, wherein

the extraction means receives the transfer instruction two or more times, and

the detection means further measures a frequency of updates in the range for which the writing is detected and, in a case of detecting that the frequency surpasses a preset frequency, excludes the range from the monitoring range thereafter.

(Supplementary Note 5)

An information processing system including the data transmission device according to any one of Supplementary Notes 1 to 4, including:

the transfer-destination node.

(Supplementary Note 6)

A data transmission method, including:

detecting writing to a memory to which writing is carried out by a processor and storing an update range, which is a range for which writing is detected in the memory, in an update range storage means;

receiving, from the processor, a transfer instruction which specifies a transfer range in the memory and, at every reception, extracting, as a transfer execution range, a range which is included in the update range, within the received transfer range; and

carrying out data transfer to transfer, to a transfer-destination node, data stored in the transfer execution range in the memory.

(Supplementary Note 7)

A data transmission program that makes a computer, which includes a memory and a processor to carry out writing to the memory, operate as:

detection means for detecting writing to the memory and storing an update range, which is a range for which writing is detected in the memory, in update range storage means;

the update range storage means;

extraction means for receiving, from the processor, a transfer instruction which specifies a transfer range in the memory and, at every reception, extracting, as a transfer execution range, a range which is included in the update range, within the received transfer range; and

transfer means for carrying out data transfer to transfer, to a transfer-destination node, data stored in the transfer execution range in the memory.

(Supplementary Note 8)

The data transmission program according to Supplementary Note 7 that makes the computer operate as:

the detection means that receives, from the processor, a detection range which is a range for which writing is detected in the memory, and detects writing to the memory within the detection range; and

the extraction means that, in addition to the transfer execution range, extracts, as the transfer execution range, a range which is not included in the detection range, within the transfer range.

(Supplementary Note 9)

The data transmission program according to Supplementary Note 8 that makes the computer operate as:

the extraction means that receives the transfer instruction two or more times; and

the detection means that, in a case of a size of the detected update range being less than a preset size, excludes the update range from the detection range thereafter.

(Supplementary Note 10)

The data transmission program according to Supplementary Note 8 or 9 that makes the computer operate as:

the extraction means that receives the transfer instruction two or more times; and

the detection means that further measures a frequency of updates in the range for which the writing is detected and, in a case of detecting that the frequency surpasses a preset frequency, excludes the range from the monitoring range thereafter.

The present invention was described above through exemplary embodiments thereof, but the present invention is not limited to the above exemplary embodiments. Various modifications that could be understood by a person skilled in the art may be applied to the configurations and details of the present invention within the scope of the present invention.

This application claims priority based on Japanese Patent Application No. 2012-268120, filed on Dec. 7, 2012, the entire disclosure of which is incorporated herein by reference.

### REFERENCE SIGNS LIST

1, 1A, 1B Host node
1C Data transmission device
1D Transfer-source node
3 Accelerator node (Transfer-destination node, Accelerator)
3A Accelerator node
3D Transfer-destination node
4 Connection network
10 Detection unit
11 Update range storage unit
12 Extraction unit
13 Transfer unit
14 Transferred range storage unit
15 History storage unit
16 Deletion unit
20, 30 Processor
21, 31 Memory
22 Instruction unit
32 Reception unit
40, 40A, 40B, 40C, 40D Program
41 Offload processing calling unit
50 Offload library
50A, 50C Data transfer library
50B Data monitoring library
51 Data monitoring instruction unit
52 Data monitoring unit
53 Data transfer instruction unit
54 Data transfer determination unit
55 Processing instruction unit
56 Data monitoring determination unit
60, 60A Accelerator library
60B Communication library
61 Data transfer execution unit
62 Processing calling unit
63 DTU calling unit
65, 65A Data transfer unit
70, 70A OS
71 Memory access control unit
72 Accelerator driver
73 Communication driver
75 Memory protection unit
80, 80A CPU
81 Memory access monitoring unit
90 Main memory
91 Data update table
100, 100A, 100B, 100C, 100D Information processing system
521 Memory protection setting unit
522 Exception handling unit

What is claimed is:

1. A data transmission device, comprising:
a memory;
a processor that carries out writing to the memory;
a detection unit that detects writing to the memory and identifies an update range, which is a range for which writing is detected in the memory;
an extraction unit that, in response to receiving, from the processor, a transfer instruction which specifies a transfer range in the memory, extracts, as a transfer execution range, a range included in the update range within the received transfer range; and
a transfer unit that carries out data transfer to transfer data stored in the transfer execution range in the memory to a transfer-destination node.

2. The data transmission device according to claim 1, wherein
the detection unit receives, from the processor, a monitoring range which is a range for which writing is detected in the memory, and detects writing to the memory within the monitoring range, and
the extraction unit, in addition to the transfer execution range, extracts, as the transfer execution range, a range which is not included in the monitoring range, within the transfer range.

3. The data transmission device according to claim 2, wherein
the extraction unit receives the transfer instruction two or more times, and
the detection unit, in a case of a size of the detected update range being less than a preset size, excludes the update range from the monitoring range thereafter.

4. The data transmission device according to claim 2, wherein
the extraction unit receives the transfer instruction two or more times, and
the detection unit further measures a frequency of updates in the range for which the writing is detected and, in a case of detecting that the frequency surpasses a preset frequency, excludes the range from the monitoring range thereafter.

5. The data transmission device according to claim 1 further comprising:
an update range storage unit that stores the update range, wherein
the detection unit stores the identified update range in the update range storage unit.

6. An information processing system including the data transmission device according to claim 1 comprising:
the transfer-destination node.

7. A data transmission method, comprising:
detecting writing to a memory to which writing is carried out by a processor and identifying an update range which is a range for which writing is detected in the memory;
in response to receiving, from the processor, a transfer instruction which specifies a transfer range in the memory, extracting, as a transfer execution range, a range included in the update range within the received transfer range; and
carrying out data transfer to transfer data stored in the transfer execution range in the memory to a transfer-destination node.

8. A non-transitory computer readable recording medium storing a data transmission program making a computer, which includes a memory and a processor to carry out writing to the memory, operate as:
a detection unit that detects writing to the memory and identifies an update range which is a range for which writing is detected in the memory;
an extraction unit that, in response to receiving, from the processor, a transfer instruction which specifies a transfer range in the memory, extracts, as a transfer execution range, a range included in the update range within the received transfer range; and
a transfer unit that carries out data transfer to transfer data stored in the transfer execution range in the memory to a transfer-destination node.

9. The non-transitory computer readable recording medium according to claim 8, storing the data transmission program making the computer operate as:
the detection unit that receives, from the processor, a monitoring range which is a range for which writing is detected in the memory, and detects writing to the memory within the monitoring detection range; and
the extraction unit that, in addition to the transfer execution range, extracts, as the transfer execution range, a range which is not included in the monitoring range, within the transfer range.

10. The non-transitory computer readable recording medium according to claim 9, storing the data transmission program making the computer operate as:
the extraction unit that receives the transfer instruction multiple times; and
the detection unit that, in case of a size of the detected update range being less than a preset size, excludes the update range from the monitoring range thereafter.
